(19) United States
(12) Patent Application Publication
(10) Pub. No.: US 2026/0156211 A1
(43) Pub. Date: Jun. 4, 2026

(54) INFORMATION PROCESSING APPARATUS, INFORMATION PROCESSING SYSTEM AND COMMUNICATION CONTROL METHOD

(71) Applicant: SHARP KABUSHIKI KAISHA, Sakai City (JP)

(72) Inventor: Reina KOJIMA, Sakai City (JP)

(21) Appl. No.: 19/401,818

(22) Filed: Nov. 26, 2025

(30) Foreign Application Priority Data
Nov. 29, 2024 (JP) 2024-207884
Oct. 1, 2025 (JP) 2025-165505

(51) Int. Cl. H04M 1/72436; H04L 67/50; H04M 1/72451; G06F 40/20

(52) U.S. Cl. CPC H04M 1/72436; H04L 67/535; H04M 1/72451; G06F 40/20

(57) ABSTRACT

An information processing apparatus includes an acquirer that acquires contact information indicating content of a contact to a second user, the content being input according to an operation of a first user, and one or more controllers that execute determining a communication tool based on urgency regarding the contact information and status information indicating a state of the second user, and execute processing for presenting information indicating the communication tool to the first user.

The present application claims priority from Japanese Application JP2024-207884, filed on November 29, 2024, and Japanese Application JP2025-165505, filed on October 1, 2025, the content of which is hereby incorporated by reference into this application.

### BACKGROUND

### 1. Field

The present disclosure relates to an information processing apparatus, an information processing system, and a communication control method.

### 2. Description of the Related Art

A related art discloses a technology that determines a degree of workload of a user based on a situation of the user, determines timing convenient for users to contact each other based on the degree of workload of the user, and executes processing for making contact at the determined timing.

In the related art, when a contact destination user is determined to be busy, the contact is scheduled, and contact between users is suppressed until the timing is determined to be convenient for them. Therefore, in the related art, there is a possibility that a contact source user cannot make contact smoothly when the user wants to make contact urgently. Accordingly, an object of an aspect of the present disclosure is to provide an information processing apparatus, an information processing system, and a communication control method that can contribute to smooth contact between a contact source user and a contact destination user.

### SUMMARY

An information processing apparatus according to one embodiment of the present disclosure includes: an acquirer to acquire contact information indicating content of a contact to a second user, the contact information being input according to an operation of a first user; and one or more controllers to execute determination of a communication tool based on urgency regarding the contact information and status information indicating a state of the second user, and execute processing for presenting information indicating the communication tool to the first user.

An information processing system according to one embodiment of the present disclosure includes: a first terminal operated by a first user; a second terminal operated by a second user; and a server apparatus communicable with the first terminal and the second terminal. The server apparatus includes: an acquirer to acquire, from the first terminal, contact information indicating content of a contact to the second user, the contact information being input according to an operation of the first user; and one or more controllers to execute determination of a communication tool based on urgency regarding the contact information and status information indicating a state of the second user, and execute processing for presenting information indicating the communication tool to the first user.

A communication control method according to one embodiment of the present disclosure causes a computer to execute processing of: acquiring contact information indicating content of a contact to a second user, the contact information being input according to an operation of a first user; determining a communication tool based on urgency regarding the contact information and status information indicating a state of the second user; and presenting information indicating the communication tool to the first user.

### BRIEF DESCRIPTION OF THE DRAWINGS

FIG. 1 is a block diagram illustrating an example of an overall configuration of an information processing system.

FIG. 2 is a block diagram illustrating an example of a configuration of a terminal.

FIG. 3 is a block diagram illustrating an example of a configuration of a server apparatus.

FIG. 4 is a diagram illustrating an example of a user information database.

FIG. 5 is a diagram illustrating an example of communication tool information.

FIG. 6 is a flowchart illustrating an example of an operation of the server apparatus.

FIG. 7 is a flowchart illustrating an example of the operation of the server apparatus subsequent to FIG. 6.

FIG. 8 is a sequence diagram illustrating a first example of an operation of the information processing system.

FIG. 9 is a sequence diagram illustrating the first example of the operation of the information processing system subsequent to FIG. 8.

FIG. 10 is a diagram illustrating an example of a screen displayed on a displayer of a first terminal in the first example.

FIG. 11 is a diagram illustrating an example of a screen subsequent to FIG. 10 displayed on the displayer of the first terminal in the first example.

FIG. 12 is a diagram illustrating an example of a screen subsequent to FIG. 11 displayed on the displayer of the first terminal and an example of a screen displayed on a displayer of a second terminal in the first example.

FIG. 13 is a diagram illustrating an example of a screen subsequent to FIG. 12 displayed on the displayer of the first terminal and an example of a screen subsequent to FIG. 12 displayed on the displayer of the second terminal in the first example.

FIG. 14 is a diagram illustrating an example of a screen subsequent to FIG. 13 displayed on the displayer of the first terminal and an example of a screen subsequent to FIG. 13 displayed on the displayer of the second terminal in the first example.

FIG. 15 is a sequence diagram illustrating a second example of the operation of the information processing system.

FIG. 16 is a sequence diagram illustrating an example of the operation of the information processing system subsequent to FIG. 15.

FIG. 17 is a sequence diagram illustrating a third example of the operation of the information processing system.

FIG. 18 is a sequence diagram illustrating an example of the operation of the information processing system subsequent to FIG. 17.

FIG. 19 is a diagram illustrating an example of a screen displayed on the displayer of the first terminal and an example of a screen displayed on the displayer of the second terminal in the third example.

FIG. 20 is a flowchart illustrating an example of an operation of a server apparatus according to a second embodiment.

FIG. 21 is a diagram illustrating an example of a screen displayed on the displayer of the first terminal.

FIG. 22 is a block diagram illustrating an example of a configuration of a server apparatus according to a third embodiment.

FIG. 23 is a diagram illustrating an example of priority contact method information.

FIG. 24 is a flowchart illustrating an example of an operation of the server apparatus according to the third embodiment.

FIG. 25 is a diagram illustrating an example of a screen displayed on the displayer of the first terminal.

FIG. 26 is a diagram illustrating an example of a screen displayed on the displayer of the first terminal.

FIG. 27 is a flowchart illustrating an example of an operation of a server apparatus according to a fifth embodiment.

FIG. 28 is a flowchart illustrating an example of the operation of the server apparatus subsequent to FIG. 27.

FIG. 29 is a diagram illustrating an example of a screen displayed on the displayer of the first terminal.

### DETAILED DESCRIPTION OF THE DISCLOSURE

### First Embodiment

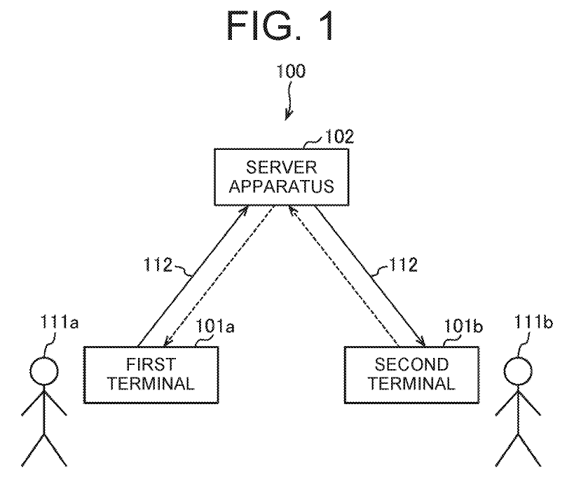

A first embodiment will be described with reference to FIGS. 1 to 19. In the drawings, the same or similar elements are assigned the same reference numerals, and redundant descriptions are omitted.

FIG. 1 is a block diagram illustrating an example of an overall configuration of an information processing system 100 according to the present embodiment. The information processing system 100 includes a first terminal 101a, a second terminal 101b, and a server apparatus (information processing apparatus) 102.

The first terminal 101a is a terminal operated by a first user 111a, who is a contact source. The first terminal 101a accepts input of content of a contact from the first user 111a to a second user 111b. Then, the first terminal 101a transmits contact information 112 indicating the input content of the contact to the server apparatus 102. For example, the first terminal 101a is a smartphone, a personal computer (PC), a tablet terminal, or a desktop PC. For example, the first terminal 101a can use telephone, chat, and email. Alternatively, the first terminal 101a may use telephone, chat, and email provided in a device different from the first terminal 101a.

The second terminal 101b is a terminal operated by the second user 111b, who is a contact destination. For example, the second terminal 101b is a smartphone, a PC, a tablet terminal, or the like. For example, the second terminal 101b can use telephone, chat, and email. Alternatively, the second terminal 101b may use telephone, chat, and email provided in the second terminal 101b.

The server apparatus 102 is an information processing apparatus communicable with the first terminal 101a and the second terminal 101b. The server apparatus 102 determines a communication tool to be used for contact between the first user 111a and the second user 111b. Specifically, the server apparatus 102 determines the communication tool based on urgency regarding the contact and a state of the second user 111b. Then, the server apparatus 102 mediates contact between the first user 111a and the second user 111b by notifying the second user 111b of the content of the contact from the first user 111a.

In the following description, the first terminal 101a and the second terminal 101b may be referred to as a terminal 101 when not distinguished from each other. In the following description, the first user 111a and the second user 111b may be referred to as a user 111 when not distinguished from each other.

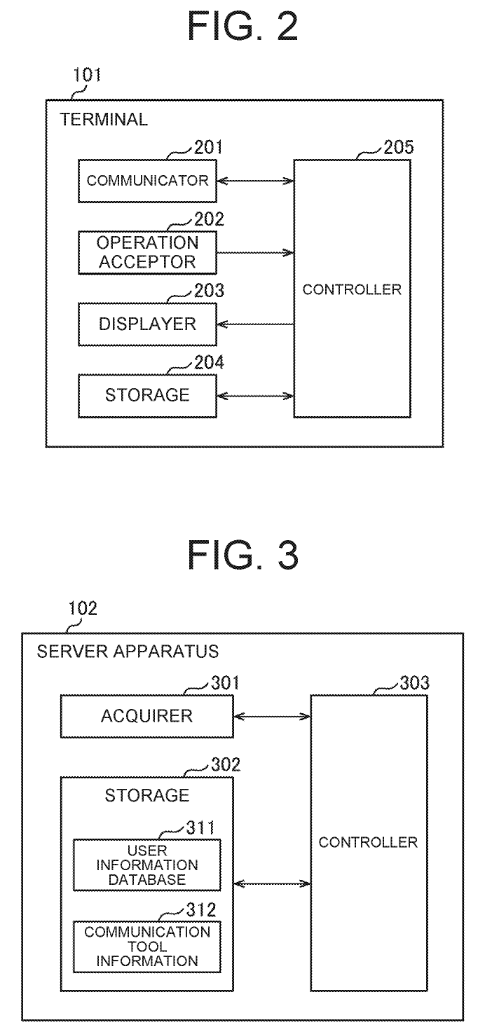

FIG. 2 is a block diagram illustrating an example of a configuration of the terminal 101. The terminal 101 includes a communicator 201, an operation acceptor 202, a displayer 203, a storage 204, and one or more controllers 205.

The communicator 201 is an interface that connects to a network.

The operation acceptor 202 accepts an operation from the user 111. For example, the operation acceptor 202 of the first terminal 101a accepts an operation for inputting content of a contact from the first user 111a to the second user 111b. For example, the operation acceptor 202 is configured by a mouse, a keyboard, a touch panel, or the like.

The displayer 203 displays information to be presented to the user 111. For example, the displayer 203 is configured by a liquid crystal panel, an organic electro-luminescence (EL) panel, or the like. The operation acceptor 202 and the displayer 203 may be configured as a touch panel display in which they are integrated.

The storage 204 is a storage medium capable of storing various data and programs. For example, the storage 204 is configured by one or more hard disk drives (HDDs), one or more solid state drives (SSDs), and one or more semiconductor memories. The storage 204 stores a telephone application program, a chat application program, an email application program, and schedule information. The schedule information indicates a schedule of the user 111.

The controller 205 controls the entire terminal 101. The controller 205 realizes various functions by reading and executing various programs stored in the storage 204. The controller 205 may be realized by one or more control devices/arithmetic devices (a central processing unit (CPU), a system on a chip (SoC)), one or more random access memories (RAMs), one or more read only memories (ROMs), and various interface circuits. Further, a part or all of the processors included in the controller 205 may be configured by an electronic circuit.

FIG. 3 is a block diagram illustrating an example of a configuration of the server apparatus 102. The server apparatus 102 includes an acquirer 301, a storage 302, and one or more controllers 303.

The acquirer 301 acquires contact information 112 indicating content of a contact to the second user 111b, the contact information being input according to an operation of the first user 111a. For example, the acquirer 301 acquires, from the first terminal 101a via a network, the contact information 112 indicating the content of the contact input to the first terminal according to the operation of the first user 111a when the first user 111a contacts the second user 111b. For example, the acquirer 301 includes an interface that connects to the network.

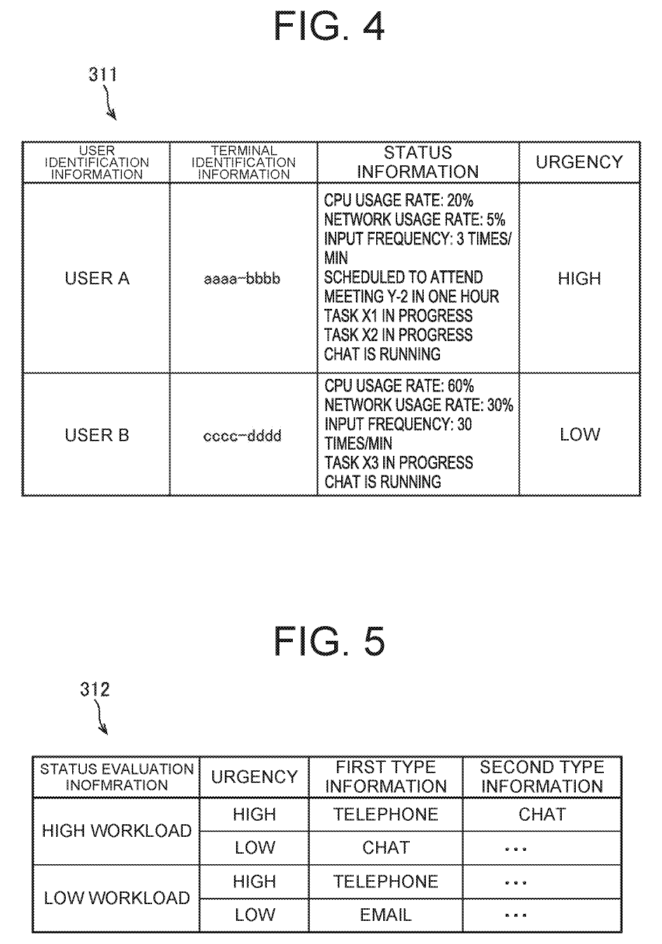

The storage 302 is a storage medium capable of storing various data and programs. For example, the storage 302 is configured by one or more HDDs, one or more SSDs, and one or more semiconductor memories. The storage 302 stores a user information database 311 (see FIG. 3) and communication tool information 312 (see FIG. 4).

The controller 303 controls the entire server apparatus 102. The controller 303 realizes various functions by reading and executing various programs stored in the storage 302. The controller 303 may be realized by one or more control devices/arithmetic devices (a CPU, an SoC), one or more RAMs, one or more ROMs, and various interface circuits. Further, a part or all of the processors included in the controller 205 may be configured by an electronic circuit.

The controller 303 executes processing for determining a communication tool based on urgency regarding the contact information 112 and status information indicating a state of the second user 111b, and executes processing for presenting information indicating the communication tool to the first user 111a. The controller 303 notifies the second user 111b of the content of the contact using the determined communication tool. In the present disclosure, the urgency is related to an importance of the content of the contact and a response waiting time for the content of the contact. The communication tool is at least one selected from the group consisting of telephone, chat, and email.

Specifically, the controller 303 determines a first communication tool based on the urgency regarding the contact information 112 and the status information indicating the state of the second user 111b. Then, the controller 303 notifies the second user 111b of the content of the contact using the first communication tool. Furthermore, when there is no contact from the second user 111b to the first user 111a via the first communication tool, the controller 303 may determine a second communication tool based on the urgency regarding the contact information 112 and the status information indicating the state of the second user 111b. When the controller 303 determines the second communication tool, the controller 303 notifies the second user 111b of the content of the contact using the second communication tool.

The controller 303 executes processing for acquiring the user information database 311 (see FIG. 4) from various apparatuses and various information databases.

FIG. 4 is a diagram illustrating an example of the user information database 311. The user information database 311 is a database that manages information of users by associating terminal identification information, status information, and urgency with user identification information. The user identification information is information that identifies the user 111. For example, the user identification information indicates a user name. The terminal identification information is information that identifies the terminal 101 used by the user having the user name indicated by the user identification information. For example, the terminal identification information indicates a telephone number, a media access control (MAC) address, or the like assigned to the terminal 101.

The status information registered in the user information database 311 indicates a state of the user 111 identified by the user identification information associated with the status information. For example, the status information includes at least one selected from the group consisting of: operational state information of the terminal 101 indicated by the terminal identification information associated with the status information; operation information regarding an operation accepted by a peripheral device connected to the terminal 101; schedule information of the user 111; attendance information of the user 111; and task information indicating a task assigned to the user 111.

For example, the user information database 311 illustrated in FIG. 4 indicates that "aaaa-bbbb" is registered in association with user identification information indicating User A. Furthermore, for example, the status information registered in the user information database 311 illustrated in FIG. 4 indicates that a CPU usage rate in the terminal 101 having the terminal identification information "aaaa-bbbb" is 20%, and a network usage rate in the terminal 101 is 5%. Furthermore, for example, the status information registered in the user information database 311 illustrated in FIG. 4 indicates that a peripheral device connected to the terminal 101 having the terminal identification information "aaaa-bbbb" accepts input operations three times per minute. Furthermore, for example, the status information registered in the user information database 311 illustrated in FIG. 4 indicates that tasks assigned to User A are Task X1 and Task X2. Furthermore, for example, the status information registered in the user information database 311 illustrated in FIG. 4 indicates that User A is scheduled to attend Meeting Y-2 in one hour.

FIG. 5 is a diagram illustrating an example of the communication tool information 312. The communication tool information 312 indicates status evaluation information, urgency, first type information, and second type information in association with each other. The status evaluation information indicates a degree of workload. In this example, "high workload" indicated by the status evaluation information indicates being busy. "Low workload" indicated by the status evaluation information indicates not being busy. The first type information indicates a type of the first communication tool. The second type information indicates a type of the second communication tool. Note that the status evaluation information, the urgency, the first type information, and the second type information indicated by the communication tool information 312 illustrated in FIG. 5 are applied to each user indicated by the user information database 311.

For example, when the status evaluation information indicates "high workload" and the urgency indicates "high", the type of the first communication tool is telephone, and the type of the second communication tool is chat.

For example, when the status evaluation information indicates "high workload" and the urgency indicates "low", the type of the first communication tool is chat, and the second communication tool is not set.

For example, when the status evaluation information indicates "low workload" and the urgency indicates "high", the type of the first communication tool is telephone, and the second communication tool is not set.

For example, when the status evaluation information indicates "low workload" and the urgency indicates "low", the type of the first communication tool is email, and the second communication tool is not set.

Although FIG. 5 illustrates that the status evaluation information indicates "high workload" or "low workload", this is not intended to limit the status evaluation information to two levels. The status evaluation information may be indicated by three or more levels. The status evaluation information may also be indicated by a numerical value. Similarly, although FIG. 5 illustrates that the urgency indicates "high" or "low", this is not intended to limit the urgency to two levels. The urgency may be indicated by three or more levels. The urgency may also be indicated by a numerical value.

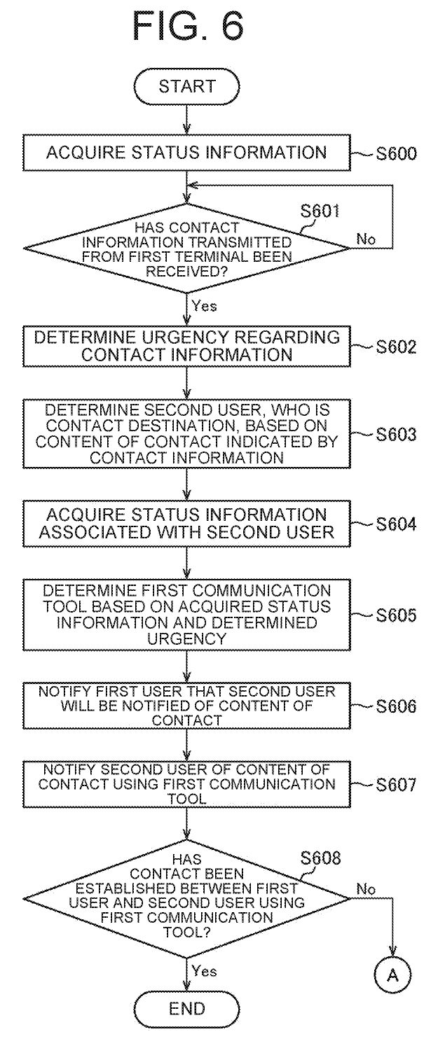

FIG. 6 is a flowchart illustrating an example of an operation of the server apparatus 102. In the following description, it is assumed that an application program for realizing the information processing system 100 according to the present embodiment is installed in the first terminal 101a and the second terminal 101b, or the application program is mounted thereon.

In step S600, the controller 303 acquires status information from the terminals 101. That is, the controller 303 acquires status information from the first terminal 101a and the second terminal 101b. For example, the controller 303 executes the processing of step S600 at predetermined time intervals. Specifically, the controller 205 transmits, to the server apparatus 102, at least one of information regarding an operational state of the terminal 101 and information regarding an operation accepted by a peripheral device (not illustrated) connected to the terminal 101. Then, the controller 303 registers the status information in the user information database 311, associating the status information with terminal identification information indicating the terminal 101 that is the transmission source of the acquired status information. The status information indicates at least one selected from the group consisting of: information regarding a schedule of the user 111; information regarding attendance of the user 111; information regarding a task assigned to the user 111; information regarding a usage status of a communication tool in the terminal 101; information regarding an operational state of the terminal 101; and information regarding an operation accepted by a peripheral device (not illustrated) connected to the terminal 101. For example, the information regarding attendance indicates office arrival, office departure, or leave.

In step S601, the controller 303 determines whether the contact information 112 transmitted from the first terminal 101a has been received. Specifically, it is assumed that the first terminal 101a has accepted an operation for inputting content of a contact. In this case, the controller 205 of the first terminal 101a transmits the contact information 112 indicating the input content of the contact to the server apparatus 102.

If the server apparatus 102 has not received the contact information 112 in step S601, the controller 303 returns the processing to step S601. On the other hand, if the server apparatus 102 has received the contact information 112 in step S601, the controller 303 stores the contact information 112 in the storage 302, and in step S602, the controller 303 determines urgency regarding the contact information 112. For example, the controller 303 determines the urgency based on a detected keyword by detecting a keyword related to urgency from the content of the contact indicated by the contact information 112 acquired in step S601. That is, the controller 303 determines the urgency from the content of the contact.

For example, the keyword related to urgency is a word related to the time until a response to the contact. For example, the keyword related to urgency indicates a preset character string such as "urgent". For example, it is assumed that the contact information 112 indicates content of a contact "Want to ask User B about the minutes of the other day's meeting urgently". In this case, for example, the controller 303 determines that the urgency is "high" based on the keyword "urgent" included in the content of the contact.

Alternatively, the keyword related to urgency may indicate a response deadline based on the current time. For example, assume that the current time is 10:00 and the contact information 112 indicates content of a contact "Please tell me about the minutes of the other day's meeting Y-1 by 10:30". In this case, for example, the controller 303 determines that the urgency is "high" based on the fact that the response deadline is 30 minutes or less from the current time.

Alternatively, assume that the contact information 112 indicates content of a contact "Want to ask about the minutes of the other day's meeting Y-1". Furthermore, assume that the status information registered in the user information database 311 indicates that User A is scheduled to attend Meeting Y-2 in one hour. In this case, the controller 303 determines that "Meeting Y-1" indicated in the content of the contact and "Meeting Y-2" indicated in the status information are related. Furthermore, the controller 303 determines that the urgency is "high" based on the fact that the status information indicates scheduled attendance at Meeting Y-2, which is related to Meeting Y-1 indicated in the content of the contact, in one hour.

Alternatively, the keyword related to urgency may be a word indicating an importance of a task included in the content of the contact. For example, assume that the contact information 112 indicates content of a contact "Want to ask User B about Task X". Then, assume that Task X is registered in the storage 302 as a task with relatively high importance. In this case, for example, the controller 303 determines that the urgency is "high" based on the keyword "Task X" included in the content of the contact.

Alternatively, when the content of the contact includes at least one of an icon indicating urgency and an image indicating urgency, the controller 303 may determine that the urgency is "high".

Alternatively, the controller 303 may determine the urgency based on the content of the contact and schedule information of the first user 111a. Specifically, the controller 303 may request the schedule information of the first user 111a from the first terminal 101a. The controller 205 of the first terminal 101a transmits the schedule information of the first user 111a stored in the storage 204 to the server apparatus 102 in response to the request from the server apparatus 102. When the controller 303 detects a keyword related to urgency from the content of the contact, the controller 303 determines the urgency based on the keyword and the schedule information of the first user 111a. On the other hand, when the controller 303 does not detect a keyword related to urgency from the content of the contact, the controller 303 determines the urgency based on the schedule information of the first user 111a.

In step S603, the controller 303 determines the second user 111b, who is the contact destination, based on the content of the contact. Specifically, the controller 303 detects a character string corresponding to user identification information registered in the user information database 311, from the content of the contact. Then, the controller 303 determines the user indicated by the detected character string as the second user 111b.

In step S604, the controller 303 acquires status information associated with the second user 111b, who was determined in step S603, from the user information database 311. Specifically, the controller 303 acquires the status information regarding the second user 111b associated with the user identification information indicating the second user 111b in the user information database 311. The status information includes at least one selected from the group consisting of: operational state information of the second terminal 101b; operation information regarding an operation accepted by a peripheral device connected to the second terminal 101b; schedule information of the second user 111b; attendance information of the second user 111b; and task information indicating a task assigned to the second user 111b.

In step S605, the controller 303 determines the first communication tool based on the status information regarding the second user 111b and the urgency determined in step S602.

For example, it is assumed that an evaluation model including evaluation values for status information is stored in the storage 302 of the controller 303. For example, the evaluation model is generated by learning the evaluation values for the acquired status information through machine learning using support vector machine (SVM) or the like. The evaluation values for status information indicate, for example, at least one selected from the group consisting of: an evaluation value for operational state information of the second terminal 101b; an evaluation value for operation information regarding an operation accepted by a peripheral device connected to the second terminal 101b; an evaluation value for schedule information of the second user 111b; an evaluation value for attendance information of the second user 111b; and an evaluation value for task information indicating a task assigned to the second user 111b.

The controller 303 calculates status evaluation information by inputting the status information regarding the second user 111b into the evaluation model. The status evaluation information indicates the degree of workload of the second user 111b. That is, the controller 303 calculates the degree of workload of the second user 111b from the status information regarding the second user 111b. Then, the controller 303 acquires, from the communication tool information 312, the first type information associated with the generated status evaluation information and the urgency. Then, the controller 303 determines the communication tool indicated by the acquired first type information as the first communication tool.

Further, when the status information regarding the second user 111b indicates information regarding a usage status of a tool, the controller 303 may determine the first communication tool based on the status evaluation information, the information regarding the usage status of the tool, and the urgency, which are indicated by the status information. For example, assume that the usage status of the tool indicated by the status information regarding the second user 111b indicates that when the second user 111b received a contact by chat in the past, it took time until the chat was viewed. Alternatively, assume that the usage status of the tool indicated by the status information regarding the second user 111b indicates that when the second user 111b received a contact by chat in the past, it took time before a reply to the chat was received. Alternatively, assume that the usage status of the tool indicated by the status information regarding the second user 111b indicates that the second user did not launch chat in the past. In this case, the controller 303 does not determine chat as the first communication tool, but determines a communication tool different from chat as the first communication tool.

In step S606, the controller 303 notifies the first user 111a that the second user 111b will be notified of the content of the contact.

In step S607, the controller 303 notifies the second user 111b of the content of the contact using the first communication tool determined in step S605. Specifically, the controller 303 determines the second terminal 101b based on the contact information acquired from the first terminal 101a, and notifies the second user 111b of the content of the contact via the determined first communication tool and second terminal 101b. For example, when the type of the first communication tool is telephone, the controller 303 transmits an audio signal indicating the content of the contact to the second terminal 101b using the telephone. Alternatively, for example, when the type of the first communication tool is telephone, the controller 303 may make a telephone call to the second terminal 101b.

Alternatively, the controller 303 may store the time from when a telephone call is made to the second terminal 101b until the second user 111b answers. Then, when the number of times the time from making a telephone call to the second terminal 101b until the second user 111b answers exceeds a threshold exceeds a reference value, the controller 303 may transmit the audio signal indicating the content of the contact to the second terminal 101b. On the other hand, when the number of times the time from making a telephone call to the second terminal 101b until the second user 111b answers exceeds the threshold does not exceed the reference value, the controller 303 may not transmit the audio signal indicating the content of the contact to the second terminal 101b, but may make a telephone call to the second terminal 101b.

Alternatively, when the type of the first communication tool is telephone, the second terminal 101b may transfer the received audio signal to a terminal different from the second terminal 101b. For example, when the second terminal 101b is a smartphone or an internet protocol (IP) telephone, the second terminal 101b may transfer the received audio signal to a personal computer (PC) communicable with the second terminal 101b.

For example, when the type of the first communication tool is chat, the controller 303 transmits a message indicating the content of the contact to the second terminal 101b using chat. For example, when the type of the first communication tool is email, the controller 303 transmits an email indicating the content of the contact to the second terminal 101b using email.

Alternatively, the controller 303 may generate a message based on the content of the contact according to the type of the first communication tool. Then, the controller 303 may transmit the generated message to the second terminal 101b using the first communication tool.

In step S608, the controller 303 determines whether contact has been established between the first user 111a and the second user 111b using the first communication tool.

For example, assume that the first communication tool is telephone. In this case, if a telephone call is established between the first user 111a and the second user 111b within a predetermined time after the controller 303 transmits the audio signal indicating the content of the contact to the second terminal 101b, the controller 303 determines that contact has been established between the first user 111a and the second user 111b. For example, when the operation acceptor 202 of the second terminal 101b accepts an operation to answer the telephone, the controller 205 transmits a signal indicating that the operation has been accepted, to the server apparatus 102. When the controller 303 receives the signal, the controller 303 determines that contact has been established between the first user 111a and the second user 111b. On the other hand, if the controller 303 receives a signal indicating that the operation acceptor 202 of the second terminal 101b has accepted an operation to answer the telephone, the controller 303 determines that contact has not been established between the first user 111a and the second user 111b.

Alternatively, after receiving a signal indicating that the operation acceptor 202 of the second terminal 101b has accepted an operation to answer the telephone and a telephone call is established between the first user 111a and the second user 111b, the controller 303 may determine whether contact has been established between the first user 111a and the second user 111b based on the content of the conversation. For example, when the controller 303 detects that the second user 111b has stated "I'm busy, please call back", the controller 303 determines that contact has not been established between the first user 111a and the second user 111b.

On the other hand, if a telephone call is not established between the first user 111a and the second user 111b within the predetermined time after the controller 303 transmits the audio signal indicating the content of the contact to the second terminal 101b, the controller 303 determines that contact has not been established between the first user 111a and the second user 111b. For example, the predetermined time is 5 minutes. Further, for example, when the content of the contact includes an instruction indicating a response deadline, such as "contact me within 10 minutes", the controller 303 may determine the predetermined time from the content of the contact.

Further, for example, assume that the first communication tool is chat. In this case, if the controller 303 determines that the message indicating the content of the contact transmitted to the second user 111b has been confirmed within a predetermined time after transmitting the message to the second terminal 101b using chat, the controller 303 determines that contact has been established between the first user 111a and the second user 111b. On the other hand, if the controller 303 does not determine that the message transmitted to the second user 111b has been confirmed within the predetermined time after transmitting the message indicating the content of the contact to the second terminal 101b using chat, the controller 303 determines that contact has not been established between the first user 111a and the second user 111b.

Further, for example, assume that the first communication tool is email. In this case, if the controller 303 determines that the email transmitted to the second user 111b has been confirmed after transmitting the email indicating the content of the contact to the second terminal 101b using email, the controller 303 determines that contact has been established between the first user 111a and the second user 111b. On the other hand, if the controller 303 does not determine that the email transmitted to the second user 111b has been confirmed after transmitting the email indicating the content of the contact indicated by the contact information 112 to the second terminal 101b using email, the controller 303 determines that contact has not been established between the first user 111a and the second user 111b.

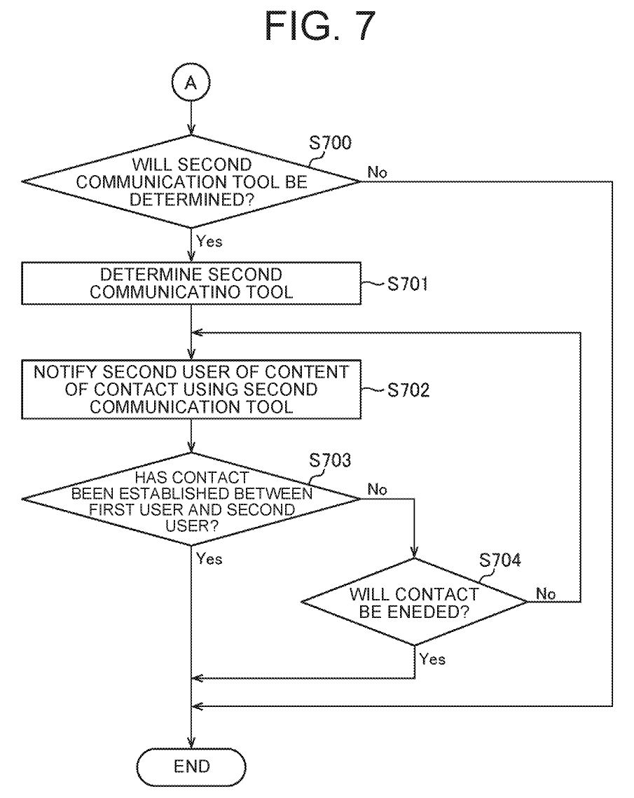

If it is determined in step S608 that contact has been established between the first user 111a and the second user 111b using the first communication tool, the controller 303 ends the processing. On the other hand, if it is determined in step S608 that contact has not been established between the first user 111a and the second user 111b using the first communication tool, the controller 303 transitions the processing to step S700 illustrated in FIG. 7.

FIG. 7 is a flowchart illustrating an example of the operation of the server apparatus 102 subsequent to FIG. 6.

In step S700, the controller 303 determines whether to determine a second communication tool. When second type information is associated with the status information regarding the second user 111b and the urgency in the communication tool information 312, the controller 303 determines to determine the second communication tool. On the other hand, when second type information is not associated with the status information regarding the second user 111b and the urgency in the communication tool information 312, the controller 303 determines not to determine the second communication tool.

If it is determined in step S700 not to determine the second communication tool, the controller 303 ends the processing. On the other hand, if it is determined in step S700 to determine the second communication tool, in step S701, the controller 303 determines the second communication tool based on the status information regarding the second user 111b and the urgency. Specifically, the controller 303 determines the communication tool indicated by the second type information associated with the status information regarding the second user 111b and the urgency as the second communication tool. That is, in step S700, the controller 303 determines whether the second communication tool is registered. If the second communication tool is not registered, the controller 303 ends the processing. On the other hand, if the second communication tool is registered, in step S701, the controller 303 selects the registered second communication tool.

In step S702, the controller 303 notifies the second user 111b of the content of the contact using the determined second communication tool. That is, when there is no contact from the second user 111b to the first user 111a via the first communication tool, the controller 303 notifies the second user 111b of the content of the contact using the second communication tool. No contact from the second user 111b to the first user 111a via the first communication tool means that contact is not established between the first user 111a and the second user 111b via the first communication tool. For example, when the type of the first communication tool is telephone, if there is no call from the second terminal 101b to the first terminal 101a, the controller 303 determines that there is no contact from the second user 111b to the first user 111a via the first communication tool. The processing of step S702 is the same as the processing of step S607 illustrated in FIG. 6, and thus detailed description thereof is omitted.

In step S703, the controller 303 determines whether contact has been established between the first user 111a and the second user 111b. The processing of step S703 is the same as the processing of step S608 illustrated in FIG. 6, and thus detailed description thereof is omitted.

If it is determined in step S703 that contact has been established between the first user 111a and the second user 111b, the controller 303 ends the processing. On the other hand, if it is not determined in step S703 that contact has been established between the first user 111a and the second user 111b, the controller 303 transitions the processing to step S704.

In step S704, the controller 303 determines whether to end the contact. For example, the controller 303 determines to end the contact when the content of the contact has been notified using the second communication tool in step S702 a predetermined number of times. On the other hand, the controller 303 determines not to end the contact when the content of the contact has not been notified using the second communication tool in step S702 the predetermined number of times. For example, the predetermined number of times is 10 times. For example, the predetermined number of times is determined by an administrator of the server apparatus 102 or the like. Alternatively, the predetermined number of times may be determined by an operation of the first user 111a on the operation acceptor 202 of the first terminal 101a or an operation of the second user 111b on the operation acceptor 202 of the second terminal 101b.

Alternatively, the controller 303 may estimate timing at which contact will be established between the first user 111a and the second user 111b, based on the schedule of the second user 111b. Then, the controller 303 may execute processing for presenting the estimated timing to the first user 111a. Then, the controller 303 may determine whether to notify the content of the contact at the timing when contact will be established, based on an input of the first user 111a on the operation acceptor 202 of the first terminal 101a. If the input of the first user 111a on the operation acceptor 202 of the first terminal 101a indicates notifying the second user 111b of the content of the contact at the timing when contact will be established, the controller 303 ends the contact in step S704 and then notifies the second user 111b of the content of the contact at the timing when contact will be established. On the other hand, if the input of the first user 111a on the operation acceptor 202 of the first terminal 101a does not indicate notifying the second user 111b of the content of the contact at the timing when contact will be established, the controller 303 ends the contact in step S704 and then does not notify the second user 111b of the content of the contact at the timing when contact will be established.

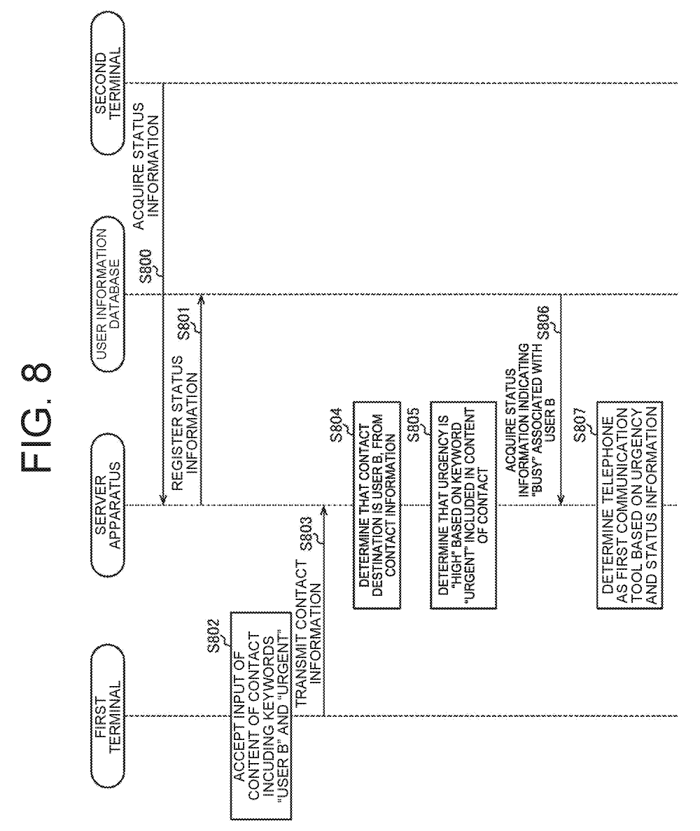

Next, an example of the operation of the information processing system 100 will be described with reference to FIGS. 8 to 19.

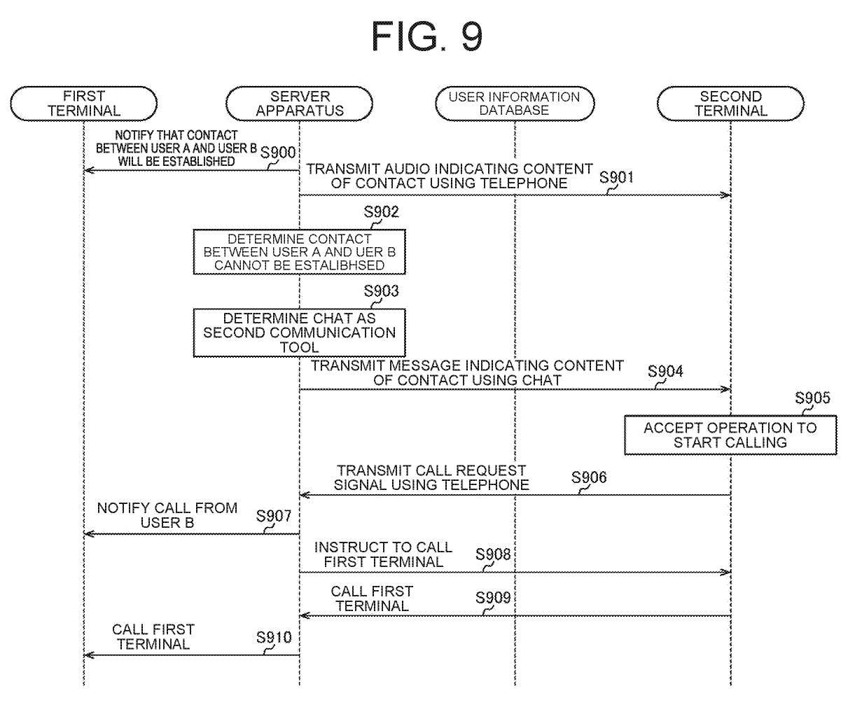

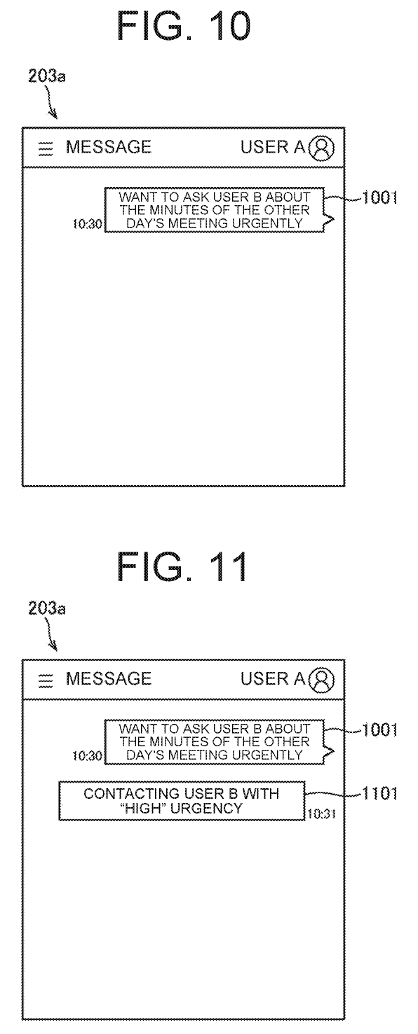

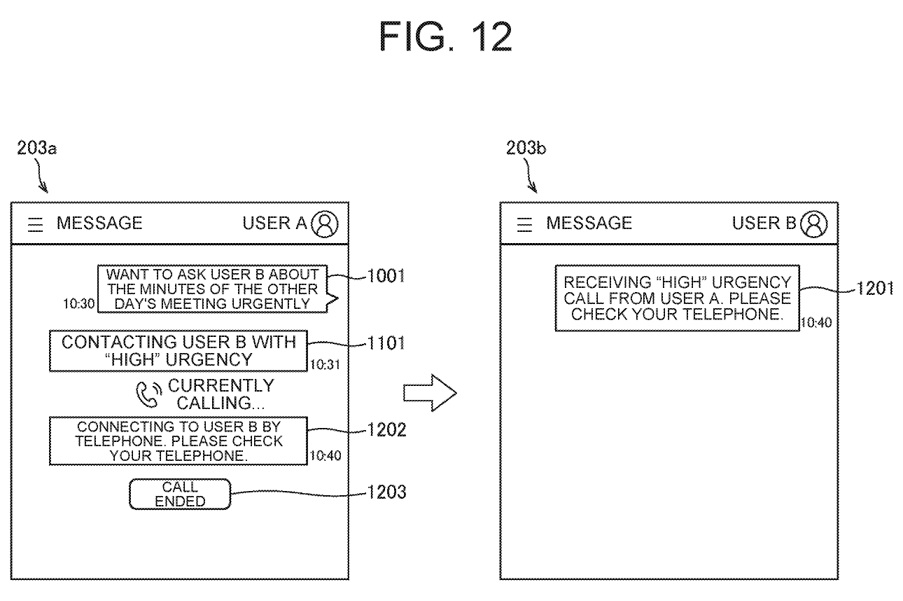

FIGS. 8 and 9 are sequence diagrams each illustrating a first example of the operation of the information processing system 100. FIGS. 10 and 11 are diagrams each illustrating an example of a screen displayed on a displayer 203a of the first terminal 101a in the first example. FIGS. 12 to 14 are diagrams illustrating an example of a screen displayed on the displayer 203a of the first terminal 101a and an example of a screen displayed on a displayer 203b of the second terminal 101b in the first example. In the following description, it is assumed that user identification information of the first user 111a indicates "User A". It is also assumed that user identification information of the second user 111b indicates "User B".

In step S800, the controller 303 acquires status information from the second terminal 101b (step S600 illustrated in FIG. 6).

In step S801, the controller 303 registers the status information acquired in step S800 in the user information database 311, associating it with the user identification information of the second user 111b.

In step S802, it is assumed that the operation acceptor 202 of the first terminal 101a has accepted an operation for inputting content of a contact including keywords "User B" and "urgent". For example, the content of the contact indicates a character string "Want to ask User B about the minutes of the other day's meeting Y-1 urgently".

In step S803, the controller 205 of the first terminal 101a transmits the contact information 112 indicating the content of the contact input in step S802 to the server apparatus 102.

In step S804, the controller 303 determines that the contact destination is "User B" from the contact information 112 transmitted in step S803 (step S603 illustrated in FIG. 6). Specifically, the controller 303 determines that the contact destination is "User B" by detecting the character string "User B" from the contact information 112. In this example, it is assumed that status information indicating "busy" is associated with the user identification information indicating "User B" in the user information database 311.

In step S805, the controller 303 determines that the urgency is "high" based on the keyword "urgent" included in the content of the contact (step S602 illustrated in FIG. 6).

In this example, it is assumed that status information indicating "busy" is associated with the user identification information indicating "User B" in the user information database 311. In this case, in step S806, the controller 303 acquires the status information indicating "busy" associated with the user identification information indicating "User B" from the user information database 311 (step S604 illustrated in FIG. 6).

In step S807, the controller 303 determines telephone as the first communication tool based on the urgency determined in step S805 and the status information acquired in step S806 (step S605 illustrated in FIG. 6).

FIG. 9 is a sequence diagram illustrating an example of the operation of the information processing system 100 subsequent to FIG. 8.

In step S900, the controller 303 notifies the first terminal 101a that contact will be established between User A and User B (step S606 illustrated in FIG. 6).

In step S901, the controller 303 transmits an audio signal indicating the content of the contact to the second terminal 101b using the telephone (step S607 illustrated in FIG. 6).

If the second terminal 101b does not respond within a predetermined time after the controller 303 transmits the audio signal indicating the content of the contact to the second terminal 101b using the telephone, in step S902, the controller 303 determines that contact cannot be established between User A and User B (No in step S608 illustrated in FIG. 6).

Here, it is assumed that in the communication tool information 312, the second type information associated with the status information indicating "busy" and the urgency indicating "high" indicates chat. In this case, in step S903, the controller 303 determines chat as the second communication tool (step S701 illustrated in FIG. 7).

In step S904, the controller 303 transmits a message indicating the content of the contact using chat (step S702 illustrated in FIG. 7).

For example, it is assumed that in step S905, the operation acceptor 202 of the second terminal 101b has accepted an operation to start using the telephone. In this case, in step S906, the controller 205 of the second terminal 101b transmits a call request signal to the server apparatus 102. In step S907, the controller 303 notifies the first terminal 101a that the call request signal has been transmitted from the second terminal 101b. In step S908, the controller 303 instructs the second terminal 101b to make a call to the first terminal 101a using the telephone.

In step S909, the controller 205 of the second terminal 101b transmits a call signal to the server apparatus 102 using the telephone to the first terminal 101a. In step S910, the controller 303 transmits the call signal transmitted from the second terminal 101b, to the first terminal 101a. When the controller 303 determines that the operation acceptor 202 of the first terminal 101a has accepted an operation to answer the telephone, the controller 303 determines that contact has been established between the first user 111a and the second user 111b (Yes in step S703 illustrated in FIG. 7).

FIG. 10 is a diagram illustrating an example of a message 1001 regarding the processing of step S802 executed by the first terminal 101a illustrated in FIG. 8. When the operation acceptor 202 of the first terminal 101a accepts an operation for inputting the message 1001 indicating the content of the contact "Want to ask User B about the minutes of the other day's meeting Y-1 urgently." in step S802 illustrated in FIG. 8, the controller 205 of the first terminal 101a causes the displayer 203a to display the message 1001.

Although the screens illustrated in FIGS. 10 to 14 show screens of a chat application, this is not intended to limit the screens related to the information processing system 100 according to the present embodiment to screens of a chat application. For example, the information processing system 100 according to the present embodiment may support contact between the first user 111a and the second user 111b using a screen of a communication support application, a screen of a communication support service, or a browser screen displaying a communication support service, instead of the screen illustrated in FIG. 10.

Further, although FIG. 10 illustrates the message 1001 including the character string "User B", if the content of the contact is input in a state where User B is designated as the contact destination or conversation partner, the content of the contact does not need to include the character string "User B" indicating the contact destination. Further, for example, when the content of the contact is input in a state where User B is designated as the contact destination or conversation partner, the controller 303 detects a keyword related to urgency from the input content of the contact in a state where the content of the contact does not include a character string indicating the contact destination in the first terminal 101a, and determines the urgency based on the detected keyword.

FIG. 11 is a diagram illustrating an example of a screen subsequent to FIG. 10 displayed on the displayer 203a of the first terminal regarding the processing of step S900 executed by the server apparatus 102 illustrated in FIG. 9. When the controller 303 notifies the first terminal 101a that contact will be established between User A and User B in step S900, the controller 303 transmits a message 1101 to the first terminal 101a. When the first terminal 101a receives the message 1101, the controller 205 of the first terminal 101a causes the displayer 203a to display the message 1101. For example, the message 1101 indicates a notification "Contacting User B with 'high' urgency." This allows the server apparatus 102 to make the first user 111a recognize that the contact information 112 has been accepted.

FIG. 12 is a diagram illustrating an example of a screen subsequent to FIG. 11 displayed on the displayer 203a and an example of a screen displayed on the displayer 203b, regarding the processing of steps S901 to S902 executed by the server apparatus 102 illustrated in FIG. 9.

When the controller 303 transmits an audio signal indicating that a contact request has been accepted, to the second terminal 101b using the telephone in step S901, the controller 303 transmits a message 1201 to the second terminal 101b. The controller 205 of the second terminal 101b causes the displayer 203b to display the message 1201. For example, the message 1201 indicates a notification "Receiving a 'high' urgency call from User A. Please check your telephone." This allows the server apparatus 102 to make the second user 111b recognize that the first user 111a is requesting contact. Furthermore, when the controller 303 transmits the audio signal indicating that a contact request has been accepted, to the second terminal 101b using the telephone in step S901, the controller 205 of the first terminal 101a causes the displayer 203a to display a message 1202. For example, the message 1202 indicates a notification "Connecting to User B by telephone. Please check your telephone." That is, the controller 303 executes processing for presenting information indicating the communication tool to the first user 111a. Then, the controller 205 of the first terminal 101a causes the displayer 203 of the first terminal 101a to display the information indicating the communication tool. This allows the server apparatus 102 to make the first user 111a recognize that a call signal is being transmitted to the second terminal 101b using the telephone.

When the controller 303 determines in step S902 that contact cannot be established between User A and User B, the controller 303 terminates making the call to the second terminal 101b using the telephone. Then, the controller 303 notifies the first terminal 101a that making the call to the second terminal 101b using the telephone has been terminated. The controller 205 of the first terminal 101a displays a message 1203 indicating that making the call is terminated because contact was not established.

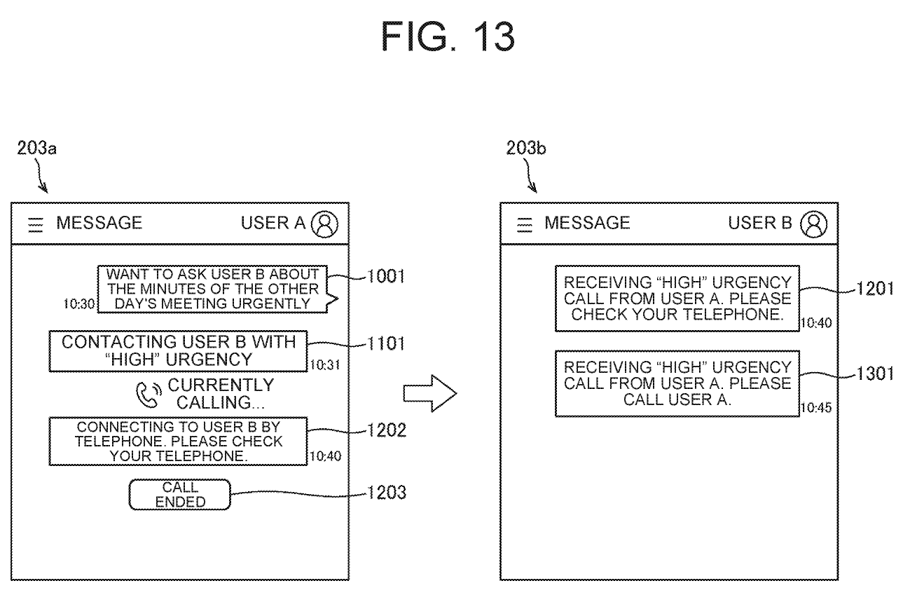

FIG. 13 is a diagram illustrating an example of a screen subsequent to FIG. 12 displayed on the displayer 203a and an example of a screen subsequent to FIG. 12 displayed on the displayer 203b.

When the controller 303 transmits a message indicating that a contact request has been accepted using chat in step S904 illustrated in FIG. 9, the controller 303 transmits a message 1301 to the second terminal 101b. When the second terminal 101b receives the message 1301, the controller 205 of the second terminal 101b causes the displayer 203b to display the message 1301. The message 1301 indicates a notification "Receiving a 'high' urgency call from User A. Please call User A." That is, when there is no contact from the second user 111b to the first user 111a via the first communication tool, the controller 303 executes processing for prompting the second user 111b using the second communication tool to contact the first user 111a using the first communication tool. This allows the server apparatus 102 to prompt the second user 111b to contact the first user 111a.

The controller 303 may emphasize the message 1301 by changing a display aspect of the message 1301. For example, the controller 303 displays the message 1301 in a blinking manner. Alternatively, the controller 303 may display the message 1301 with an icon indicating an urgent contact added. Alternatively, when the screen illustrated in FIG. 13 is not displayed on the displayer 203 of the second terminal 101b, the controller 303 may cause the displayer 203 of the second terminal 101b to display the message 1301 by a push notification.

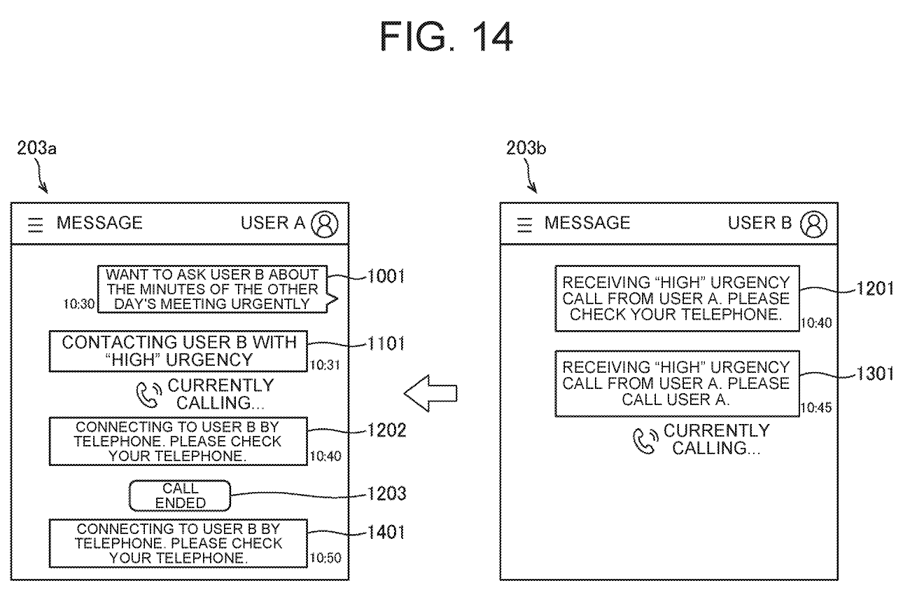

FIG. 14 is a diagram illustrating an example of a screen subsequent to FIG. 13 displayed on the displayer 203a and an example of a screen subsequent to FIG. 13 displayed on the displayer 203b, regarding step S906 illustrated in FIG. 9. In step S907, the controller 303 transmits a message 1401 to the first terminal 101a, thereby notifying the first terminal 101a that the call request signal has been transmitted from the second terminal 101b. For example, the message 1401 indicates a notification "Connecting to User B by telephone. Please check your telephone." This allows the server apparatus 102 to make the first user 111a recognize that the second user 111b is requesting a telephone call.

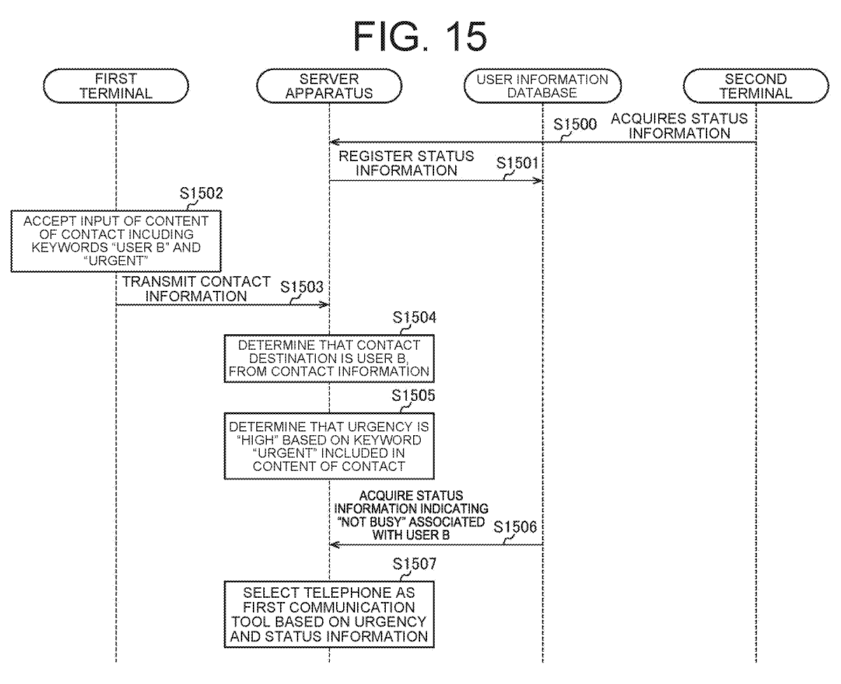

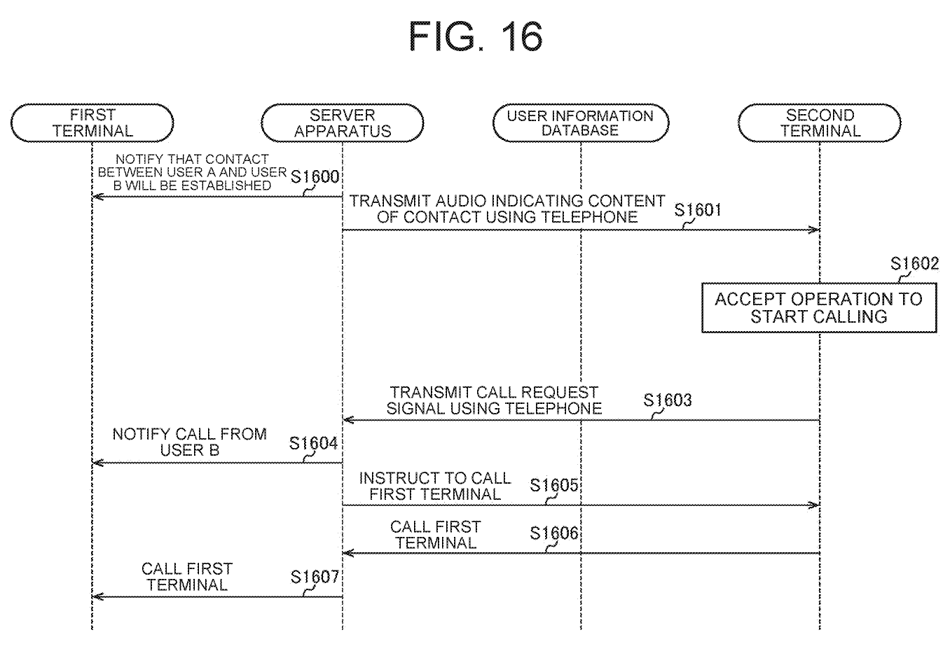

FIGS. 15 and 16 are sequence diagrams illustrating a second example of the operation of the information processing system 100.

The processing of steps S1500 to S1505 illustrated in FIG. 15 is the same as the processing of steps S800 to S805 illustrated in FIG. 8, and thus detailed description thereof is omitted.

In this example, it is assumed that status information indicating "not busy" is associated with the user identification information indicating "User B" in the user information database 311. In this case, in step S1506, the controller 303 acquires the status information indicating "not busy" associated with the user identification information indicating "User B" from the user information database 311 (step S604 illustrated in FIG. 6).

In step S1507, the controller 303 determines telephone as the first communication tool based on the urgency determined in step S1505 and the status information acquired in step S1506 (step S605 illustrated in FIG. 6).

FIG. 16 is a sequence diagram illustrating an example of the operation of the information processing system 100 subsequent to FIG. 15. The processing of steps S1600 to S1601 is the same as the processing of steps S900 to S901 illustrated in FIG. 9, and thus detailed description thereof is omitted.

It is assumed that, after the controller 303 transmits an audio signal indicating the content of the contact to the second terminal 101b using the telephone in step S1601, in step S1602, the operation acceptor 202 of the second terminal 101b has accepted a call start operation for starting a telephone call using the telephone. In this case, in step S1603, the controller 205 of the second terminal 101b transmits a call request signal to the server apparatus 102. The processing of steps S1603 to S1607 is the same as the processing of steps S906 to S910 illustrated in FIG. 9, and thus detailed description thereof is omitted.

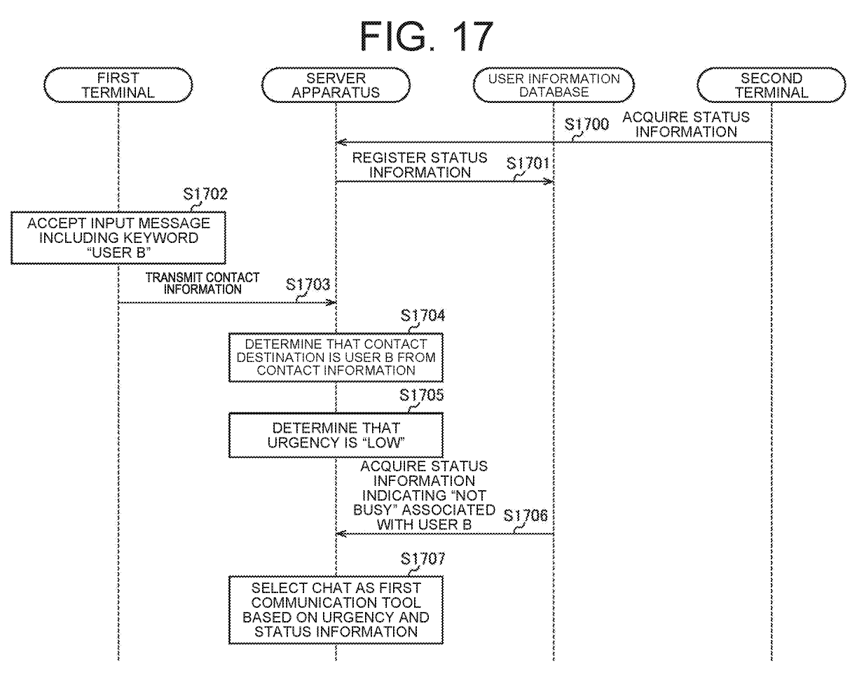

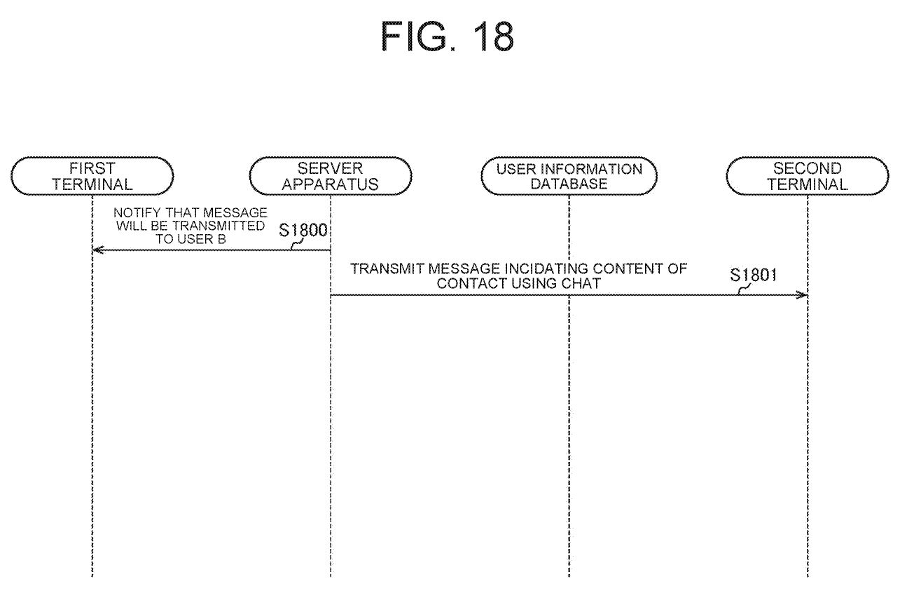

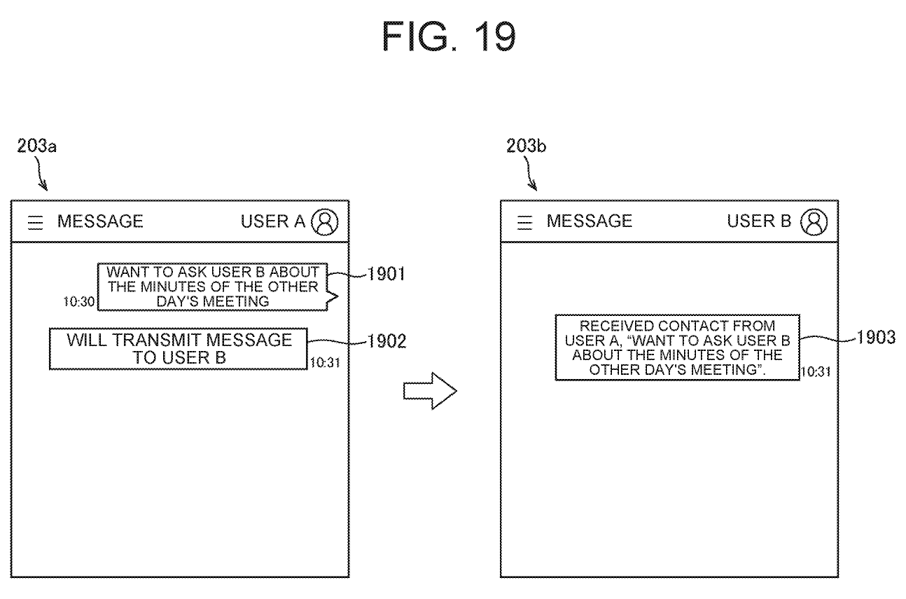

FIGS. 17 and 18 are sequence diagrams illustrating a third example of the operation of the information processing system 100. FIG. 19 is a diagram illustrating an example of a screen displayed on the displayer 203a of the first terminal 101a and an example of a screen displayed on the displayer 203b of the second terminal 101b in the third example.

In step S1702, it is assumed that the operation acceptor 202 of the first terminal 101a has accepted an operation for inputting content of a contact that includes the keyword "User B" and does not include the keyword "urgent". For example, the content of the contact indicates a character string "Want to ask User B about the minutes of the other day's meeting Y-1".

In step S1703, the controller 205 of the first terminal 101a transmits the contact information 112 indicating the content of the contact in step S1702 to the server apparatus 102. The processing of steps S1703 to S1704 is the same as the processing of steps S803 to S804 illustrated in FIG. 8, and thus detailed description thereof is omitted.

In step S1705, the controller 303 determines that the urgency is "low" because the content of the contact indicated in the contact information 112 does not include the keyword "urgent" (step S602 illustrated in FIG. 6).

Furthermore, in this example, it is assumed that status information indicating "not busy" is associated with the user identification information indicating "User B" in the user information database 311. In this case, in step S1706, the controller 303 acquires the status information indicating "not busy" associated with the user identification information indicating "User B" from the user information database 311 (step S604 illustrated in FIG. 6).

In step S1707, the controller 303 determines chat as the first communication tool based on the urgency determined in step S1705 and the status information acquired in step S1706 (step S605 illustrated in FIG. 6).

FIG. 18 is a sequence diagram illustrating an example of the operation of the information processing system 100 subsequent to FIG. 17.

In step S1800, the controller 303 notifies the first terminal 101a that a message 1902 will be transmitted to User B (step S606 illustrated in FIG. 6).

In step S1801, the controller 303 transmits a message 1903 indicating the content of the contact using chat (step S607 illustrated in FIG. 6).

FIG. 19 is a diagram illustrating an example of a screen displayed on the displayer 203a and an example of a screen displayed on the displayer 203b, regarding the processing of step S1702 illustrated in FIG. 17 and the processing of steps S1800 to S1801 illustrated in FIG. 18.

When the operation acceptor 202 of the first terminal 101a accepts an operation for inputting a message 1901 indicating the content of the contact "Want to ask User B about the minutes of the other day's meeting Y-1." in step S1702 illustrated in FIG. 17, the controller 205 of the first terminal 101a causes the displayer 203a to display the message 1901. The difference between the message 1901 and the message 1001 is that the message 1901 does not include the keyword "urgent".

When the controller 303 notifies the first terminal 101a that contact will be established between User A and User B in step S1800 illustrated in FIG. 18, the controller 303 transmits a message 1902 to the first terminal 101a. The controller 205 of the first terminal 101a causes the displayer 203a to display the message 1902. For example, the message 1902 indicates a notification "Transmitting a message to User B." This allows the server apparatus 102 to make the first user 111a recognize that the content of the contact will be notified to the second user 111b.

When the controller 303 transmits a message indicating the content of the contact using chat in step S1801 illustrated in FIG. 18, the controller 303 transmits a message 1903 to the second terminal 101b. The controller 205 of the second terminal 101b causes the displayer 203b to display the message 1903. The message 1901 indicates a notification "Received a contact from User A, 'Want to ask User B about the minutes of the other day's meeting'." This allows the server apparatus 102 to prompt the second user 111b to contact the first user 111a.

As described above, in the information processing system 100 according to the present embodiment, the server apparatus 102 can determine an appropriate communication tool according to the urgency of the contact from the first user 111a and the state of the contact destination, the second user 111b. This allows the information processing system 100 according to the present embodiment to contribute to smooth contact between the contact source user and the contact destination user.

### First Modification

As a first modification of the information processing system 100 according to the present embodiment, the server apparatus 102 may determine the first communication tool and the second communication tool according to a frequency of use of communication tools by the second user 111b. For example, a usage history of communication tools in the terminal 101 is stored in the user information database 311 in association with user identification information that identifies the user using the terminal 101. Then, the controller 303 determines the first communication tool based on the urgency and the usage history of communication tools. Specifically, when the urgency indicates "high", the controller 303 determines the most frequently used communication tool as the first communication tool based on the usage history of communication tools associated with the user identification information of the second user 111b.

For example, assume that for User B, the frequency of use of email is the highest. In this case, when the controller 303 determines that User B is the contact destination and the urgency is "high", the controller 303 determines email as the first communication tool. Then, the controller 303 notifies User B of the content of the contact using email. This allows the information processing system 100 according to the present modification to contribute to causing User B to respond earlier than in a case where User B is notified of the content of the contact using telephone.

As described above, the information processing system 100 according to the present modification determines the communication tool according to the frequency of use of communication tools by the contact destination user. As a result, the information processing system 100 according to the present modification can contribute to smooth contact between the contact source user and the contact destination user.

### Second Modification

As a second modification of the information processing system 100 according to the present embodiment, the server apparatus 102 may notify the second user 111b of the content of the contact using a plurality of communication tools. Specifically, the controller 303 according to the present modification determines whether to notify the second user 111b of the content of the contact using a plurality of communication tools, based on information indicating a usage status of tools indicated by the status information regarding the second user 111b.

For example, assume that the controller 303 has determined chat as the first communication tool. Furthermore, assume that the status information regarding the second user 111b indicates that chat is not running, and the usage history of communication tools associated with the user identification information of the second user 111b indicates that the frequency of use of chat is lower than a threshold. In this case, the controller 303 selects chat and email as the first communication tool.

Further, for example, assume that the controller 303 has determined chat as the second communication tool. Furthermore, assume that the status information regarding the second user 111b indicates that chat is not running, and the usage history of communication tools associated with the user identification information of the second user 111b indicates that the frequency of use of chat is lower than a threshold. In this case, the controller 303 may select chat and email as the second communication tool. In the above description, the controller 303 determining chat as the first communication tool and the second communication tool is merely an example, and this is not intended to limit the determination of chat as the first communication tool and the second communication tool when using a plurality of communication tools.

This allows the information processing system 100 according to the present modification to contribute to establishing contact between the first user 111a and the second user 111b using an appropriate communication tool, based on the usage status of tools of the second user 111b and the usage history of tools of the second user 111b.

### Third Modification

As a third modification of the information processing system 100 according to the present embodiment, the contact information 112 may include information indicating urgency specified by the first user 111a. Specifically, when the operation acceptor 202 of the first terminal 101a accepts an operation for inputting a message indicating content of a contact and information indicating urgency, the operation acceptor 202 transmits the information indicating urgency and the contact information 112 to the server apparatus 102. This allows the information processing system 100 according to the present modification to determine the communication tool according to the urgency specified by the contact source user.

### Fourth Modification

As a fourth modification of the information processing system 100 according to the present embodiment, the contact destination may be a group consisting of a plurality of users including the second user 111b. For example, when contact is not established between the first user 111a and the second user 111b, the controller 303 may transmit the content of the contact to a third user who belongs to the same group as the second user 111b.

For example, assume that in step S600, the server apparatus 102 has acquired information regarding attendance of the second user 111b from the second terminal 101b. Furthermore, assume that the information regarding attendance of the second user 111b indicates that the second user 111b is absent, and the urgency indicates "high" urgency. In this case, the controller 303 may determine, as the second user 111b, a third user who belongs to the group to which the second user 111b belongs and is different from the determined second user 111b. Then, the controller 303 may execute the processing of steps S604 to S605 for the new second user 111b.

On the other hand, assume that the information regarding attendance of the second user 111b indicates that the second user 111b is absent, and the urgency indicates "low" urgency. In this case, the controller 303 may determine a predetermined communication tool as the first communication tool, instead of executing the processing of step S605.

Further, for example, when the content of the contact cannot be notified using the second communication tool, the controller 303 newly determines a third user. Then, the controller 303 may execute processing for notifying the third user of the content of the contact. For example, the third user is a user who belongs to the same group as the second user. Alternatively, the first user 111a may specify the third user using the operation acceptor 202 of the first terminal 101a. Then, the first terminal 101a transmits the content of the contact and identification information of the third user to the server apparatus 102.

As described above, the information processing system 100 according to the present modification can cause the third user to take action according to the content of the contact from the first user 111a, even when it is difficult to establish contact between the first user 111a and the second user 111b. This allows the information processing system 100 according to the present modification to avoid a situation where action according to the content of the contact from the first user 111a is not taken.

### Fifth Modification

As a fifth modification of the information processing system 100 according to the present embodiment, the controller 303 may change the type of the determined first communication tool according to the determined type of the first communication tool and the content of the contact. For example, assume that the controller 303 has determined chat or email as the first communication tool by the processing of step S605 illustrated in FIG. 6. In this case, the controller 303 determines whether it is difficult to convey the content of the contact by chat or email, using machine learning, etc. When the controller 303 determines that it is difficult to convey the content of the contact by chat or email, the controller 303 changes the first communication tool to telephone. Then, the controller 303 transmits to the first user 111a that the content of the contact will be notified by telephone. This allows the information processing system 100 according to the present modification to notify the contact destination user of the content of the contact using an appropriate communication tool according to the content of the contact.

### Sixth Modification

As a sixth modification of the information processing system 100 according to the present embodiment, the controller 303 may notify the second user of the content of the contact using the second communication tool, without notifying the second user 111b of the content of the contact using the first communication tool. For example, when the status information of the second user 111b indicates "busy", the controller 303 may notify the second user of the content of the contact using the second communication tool, without notifying the second user 111b of the content of the contact using the first communication tool.

For example, assume that the type of the first communication tool associated with "high workload" indicated by the status evaluation information is telephone, and the type of the second communication tool is chat. In this case, assume that the status information of the second user 111b indicates that the second user 111b is attending a meeting that satisfies a predetermined condition or is scheduled to attend within a predetermined time. For example, the predetermined condition is being a meeting with a meeting name including a proper noun indicating a customer name, or an important meeting such as a management meeting. In this case, the controller 303 may notify the second user 111b of the content of the contact using chat, without notifying the second user 111b of the content of the contact using telephone.

Further, when contact is not established between the first user 111a and the second user 111b using the second communication tool within a predetermined time after notifying the second user of the content of the contact using the second communication tool, the controller 303 may notify the content of the contact using the first communication tool after the second user 111b becomes not busy.

As described above, the information processing system 100 according to the present modification can contribute to establishing contact between the first user 111a and the second user 111b using an appropriate communication tool according to the situation of the second user 111b.

### Second Embodiment

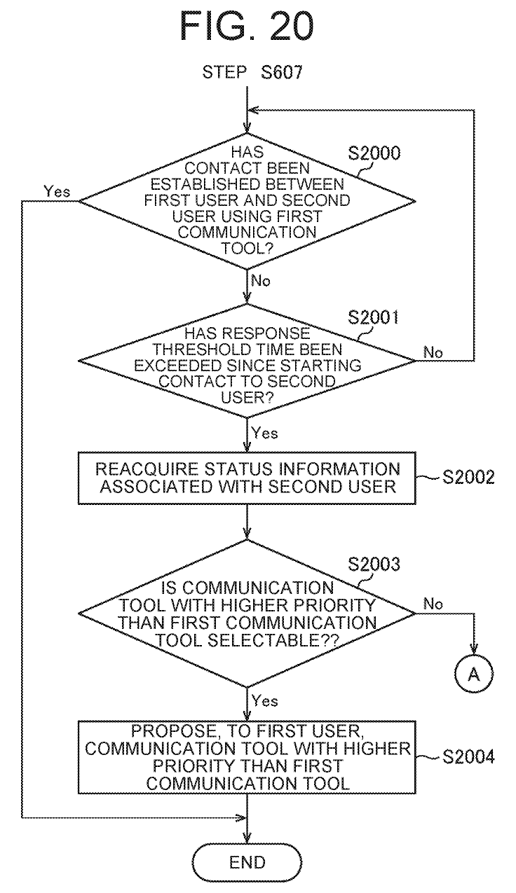

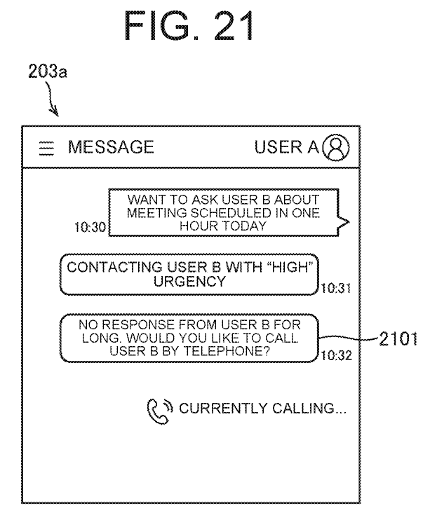

A second embodiment will be described with reference to FIGS. 20 and 21. In the drawings, the same or similar elements are assigned the same reference numerals, and redundant descriptions are omitted.

The controller 303 according to the present embodiment notifies the second user 111b of the content of the contact using the determined communication tool, and when time during which contact is not established between the first user 111a and the second user 111b exceeds a predetermined response threshold time, the controller 303 executes processing for presenting a communication tool with a higher priority than the determined communication tool to the first user 111a.

FIG. 20 is a flowchart illustrating an example of an operation of the server apparatus 102 according to the present embodiment.

When the controller 303 notifies the second user 111b of the content of the contact using the first communication tool determined in step S605 illustrated in FIG. 6, then in step S607 illustrated in FIG. 6, in step S2000, the controller 303 determines whether contact has been established between the first user 111a and the second user 111b using the first communication tool. The processing of step S2000 is the same as the processing of step S608 illustrated in FIG. 6, and thus detailed description thereof is omitted.

If it is determined in step S2000 that contact has been established between the first user 111a and the second user 111b using the first communication tool, the controller 303 ends the processing. On the other hand, if it is determined in step S2000 that contact has not been established between the first user 111a and the second user 111b using the first communication tool, in step S2001, the controller 303 determines whether a response threshold time has been exceeded since starting the contact to the second user 111b using the first communication tool.

For example, when the first communication tool is telephone, the response threshold time is 30 seconds. Further, for example, when the first communication tool is chat, the response threshold time is 30 minutes. Further, for example, when the first communication tool is email, the response threshold time is 24 hours.

If it is determined in step S2001 that the response threshold time has not been exceeded since starting the contact to the second user 111b using the first communication tool, the controller 303 returns the processing to step S2000. On the other hand, if it is determined in step S2001 that the response threshold time has been exceeded since starting the contact to the second user 111b, the controller 303 transitions the processing to step S2002. That is, if contact is not established between the first user 111a and the second user 111b using the first communication tool within the response threshold time since the contact to the second user 111b was started, the controller 303 transitions the processing to step S2002.

For example, assume that the first communication tool is chat, and the response threshold time for chat is 30 minutes. In this case, if the controller 303 does not receive a response from the second terminal 101b within 30 minutes after transmitting the message indicating the content of the contact to the second terminal 101b using chat, the controller 303 transitions the processing to step S2002.

In step S2002, the controller 303 reacquires the status information associated with the second user 111b from the user information database 311. For example, assume that after the controller 303 acquires the status information in step S604 illustrated in FIG. 6, the status information associated with the second user 111b registered in the user information database 311 is updated. In this case, the status information associated with the second user 111b acquired in step S603 illustrated in FIG. 6 and the status information associated with the second user 111b acquired in step S2002 are different. Therefore, by the controller 303 executing the processing of step S2002, the controller 303 can acquire the latest status information regarding the second user 111b.

In step S2003, the controller 303 determines whether a communication tool with a higher priority than the first communication tool can be selected. Specifically, when a type of communication tool associated with urgency higher than the urgency determined in step S602 is registered for the first type information in the communication tool information 312 illustrated in FIG. 5, the controller 303 determines that the communication tool can be selected as a communication tool with a higher priority than the first communication tool. On the other hand, when a type of communication tool associated with urgency higher than the urgency determined in step S602 illustrated in FIG. 6 is not registered for the first type information in the communication tool information 312 illustrated in FIG. 5, the controller 303 determines that the communication tool cannot be selected as a communication tool with a higher priority than the first communication tool.

If it is determined in step S2003 that a communication tool with a higher priority than the first communication tool cannot be selected, the controller 303 transitions the processing to step S700 illustrated in FIG. 7. Therefore, if it is determined that a communication tool with a higher priority than the first communication tool cannot be selected, it is determined whether to determine the second communication tool associated with the status information regarding the second user 111b and the urgency.

On the other hand, if it is determined in step S2003 that a communication tool with a higher priority than the first communication tool can be selected, in step S2004, the controller 303 executes processing for presenting the communication tool to the first user 111a. For example, the processing for presenting the communication tool to the first user 111a includes processing for causing the displayer 203a to display a message prompting contact with the second user 111b using the communication tool.

For example, assume that the controller 303 has calculated status evaluation information by inputting the status information regarding the second user 111b into the evaluation model. In this case, if the calculated status evaluation information indicates "low workload" and the urgency regarding the contact information 112 indicates "low", in step S604 illustrated in FIG. 6, the controller 303 refers to the user information database 311 illustrated in FIG. 5 and determines chat as the first communication tool. In this case, in step S2003, the controller 303 refers to the user information database 311 illustrated in FIG. 5 and determines that telephone can be selected as a communication tool with a higher priority than the first communication tool. Then, in step S2004, the controller 303 causes the displayer 203a to display a message prompting the first user 111a to contact the second user 111b using the telephone.

On the other hand, if the calculated status evaluation information indicates "low workload" and the urgency regarding the contact information 112 indicates "high", a type of the first communication tool is not registered for urgency higher than the urgency "high" in the user information database 311 illustrated in FIG. 5. Therefore, if the status evaluation information indicates "low workload" and the urgency indicates "high", in step S2003, the controller 303 determines that a communication tool with a higher priority than the first communication tool cannot be selected. In this case, the controller 303 transitions the processing to step S700 illustrated in FIG. 7.

FIG. 21 is a diagram illustrating an example of a screen displayed on the displayer 203a regarding step S2004 illustrated in FIG. 20. For example, when the first communication tool is chat, in step S2004, the controller 303 transmits a message 2101 to the first terminal 101a, thereby prompting the first user 111a to contact the second user 111b using the telephone. For example, the message 2101 indicates a notification "No response from User B. Call by telephone?" This allows the controller 303 to propose to the first user 111a to use a communication tool with a higher priority than the first communication tool.

As described above, when contact is not established between the contact source user and the contact destination user within the response threshold time using the first communication tool, the information processing system 100 according to the present embodiment selects a communication tool with a higher priority than the first communication tool. This allows the information processing system 100 according to the present embodiment to contribute to smooth contact between the contact source user and the contact destination user.

### Third Embodiment

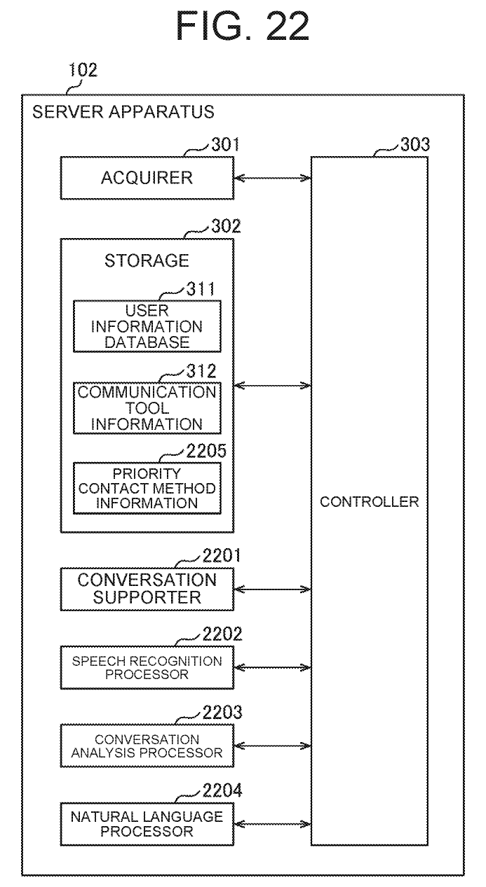

A third embodiment will be described with reference to FIGS. 22 to 25. In the drawings, the same or similar elements are assigned the same reference numerals, and redundant descriptions are omitted.

FIG. 22 is a block diagram illustrating an example of a configuration of the server apparatus 102 according to the present embodiment. The difference between the server apparatus 102 illustrated in FIG. 22 and the server apparatus 102 illustrated in FIG. 3 is that the server apparatus 102 illustrated in FIG. 22 includes a conversation supporter 2201, a speech recognition processor 2202, a natural language processor 2203, and a conversation analysis processor 2204, and priority contact method information 2205 is stored in the storage 302.

The conversation supporter 2201, the speech recognition processor 2202, and the conversation analysis processor 2204 may be realized by one or more control devices/arithmetic devices (a CPU, an SoC), one or more RAMs, one or more ROMs, and various interface circuits. For example, the conversation supporter 2201, the speech recognition processor 2202, and the conversation analysis processor 2204 may be realized by a control device or the like different from the controller 303. Alternatively, the conversation supporter 2201, the speech recognition processor 2202, the natural language processor 2203, and the conversation analysis processor 2204 may be realized by the control device that realizes the controller 303.

The conversation supporter 2201 presents information for supporting conversation to at least one of the first user 111a and the second user 111b based on a conversation between the first user 111a and the second user 111b. Specifically, when at least one of content of the conversation between the first user 111a and the second user 111b and a conversation duration of the conversation between the first user 111a and the second user 111b indicates stagnation of the conversation, the conversation supporter 2201 executes processing for presenting a communication method different from the determined communication tool to at least one of the first user 111a and the second user 111b.

The speech recognition processor 2202 executes speech recognition processing on an audio signal transmitted between the first terminal 101a and the second terminal 101b, and converts the audio signal into text information.

The natural language processor 2203 executes natural language processing on the conversation between the first terminal 101a and the second terminal 101b, and generates a summary sentence regarding the conversation between the first terminal 101a and the second terminal 101b. Specifically, the natural language processor 2203 performs parsing on text information extracted from the conversation between the first terminal 101a and the second terminal 101b, and breaks down sentences indicated by the extracted text information into elements such as a subject, a predicate, an object, and a modifier. Then, the natural language processor 2203 generates a summary sentence based on the parsing result.

The conversation analysis processor 2204 analyzes content of the conversation using telephone between the first user 111a and the second user 111b, based on the text information converted by the speech recognition processor 2202. Specifically, the conversation analysis processor 2204 analyzes the content of the conversation based on the summary sentence indicated by the natural language processor 2203.

The storage 302 according to the present embodiment further stores priority contact method information 2205. The priority contact method information 2205 indicates status evaluation information, urgency, and a priority contact method in association with each other. The priority contact method is a contact method that has priority over the first communication tool.

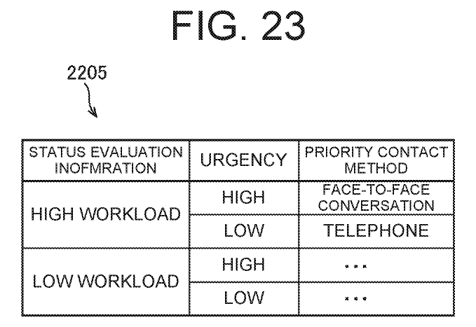

FIG. 23 is a diagram illustrating an example of the priority contact method information 2205. For example, when the status evaluation information indicates "high workload" and the urgency indicates "high", the priority contact method is face-to-face conversation. For example, when the status evaluation information indicates "high workload" and the urgency indicates "low", the priority contact method is telephone. Further, for example, when the status evaluation information indicates "low workload", the priority contact method is not set.

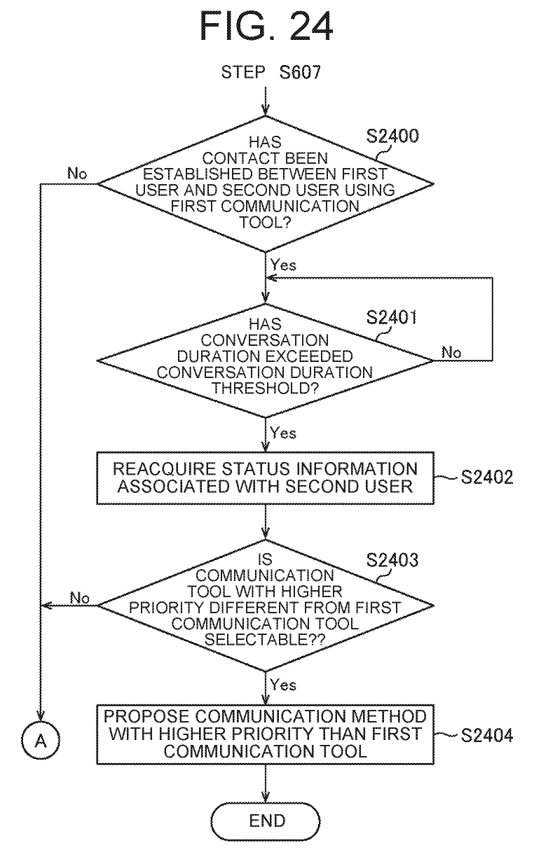

FIG. 24 is a flowchart illustrating an example of an operation of the server apparatus 102 according to the present embodiment.

When the controller 303 notifies the second user 111b of the content of the contact using the first communication tool determined in step S605 illustrated in FIG. 6, then in step S607 illustrated in FIG. 6, in step S2400, the controller 303 determines whether contact has been established between the first user 111a and the second user 111b using the first communication tool. The processing of step S2400 is the same as step S608 illustrated in FIG. 6, and thus detailed description thereof is omitted.

If it is determined in step S2400 that contact has not been established between the first user 111a and the second user 111b using the first communication tool, the controller 303 transitions the processing to step S700 illustrated in FIG. 7. On the other hand, if it is determined in step S2400 that contact has been established between the first user 111a and the second user 111b using the first communication tool, in step S2401, the conversation supporter 2201 determines whether a conversation duration has exceeded a conversation duration threshold time. For example, when the first communication tool is telephone, the conversation duration threshold time is 5 minutes. Further, for example, when the first communication tool is chat, the conversation duration threshold time is 60 minutes.

For example, when the first communication tool is chat, the conversation supporter 2201 determines whether the conversation duration since the start of the conversation using chat between the first user 111a and the second user 111b has exceeded the conversation duration threshold time.

A method for determining whether the conversation duration has exceeded the conversation duration threshold time will be described in detail.

First, the conversation analysis processor 2204 analyzes content of the conversation using chat between the first user 111a and the second user 111b. For example, the conversation analysis processor 2204 analyzes the content of the conversation by chat between the first user 111a and the second user 111b using natural language processing (NLP).

Alternatively, when the first communication tool is telephone, the conversation supporter 2201 determines whether the conversation duration using telephone between the first user 111a and the second user 111b has exceeded the conversation duration threshold time. Specifically, the speech recognition processor 2202 executes speech recognition processing on an audio signal transmitted between the first terminal 101a and the second terminal 101b, and converts the audio signal into text information. Then, the conversation analysis processor 2204 analyzes content of the conversation using telephone between the first user 111a and the second user 111b, based on the converted text information. For example, the conversation analysis processor 2204 analyzes the content of the conversation by telephone between the first user 111a and the second user 111b using natural language processing (NLP).

The conversation analysis processor 2204 determines whether the conversation between the first user 111a and the second user 111b is progressing, based on the analysis result of the content of the conversation.

For example, the conversation analysis processor 2204 determines whether a main point of an utterance of at least one of the first user 111a and the second user 111b is clear, using natural language processing. If the main point of the utterance of at least one of the first user 111a and the second user 111b is not clear, the conversation analysis processor 2204 determines that the conversation between the first user 111a and the second user 111b is stagnating.

Alternatively, when the conversation analysis processor 2204 determines that a demonstrative is used in the conversation between the first user 111a and the second user 111b, and as a result, the user 111 different from the speaker does not understand the speaker's utterance, the conversation analysis processor 2204 may determine that the conversation between the first user 111a and the second user 111b is stagnating.

Alternatively, for example, when the conversation analysis processor 2204 determines that a subject is omitted in the conversation between the first user 111a and the second user 111b, and as a result, the user 111 different from the speaker does not understand the speaker's utterance, the conversation analysis processor 2204 may determine that the conversation between the first user 111a and the second user 111b is stagnating.

Alternatively, when the first communication tool is chat, and the number of typos or unclear phrases in the conversation between the first user 111a and the second user 111b exceeds a predetermined number, the conversation analysis processor 2204 may determine that the conversation between the first user 111a and the second user 111b is stagnating.

Alternatively, when a proportion of technical terms or abbreviations included in the conversation between the first user 111a and the second user 111b exceeds a predetermined proportion, the conversation analysis processor 2204 may determine that the conversation between the first user 111a and the second user 111b is stagnating.

When it is determined that the conversation is not progressing, the conversation supporter 2201 determines whether the conversation duration has exceeded the conversation duration threshold time. Specifically, when a state determined as conversation stagnation continues for more than the conversation duration threshold time, the conversation supporter 2201 determines that the conversation duration has exceeded the conversation duration threshold time. For example, assume that the first communication tool is telephone, and the conversation duration threshold time is 5 minutes. In this case, if the conversation by telephone between the first user 111a and the second user 111b continues for 5 minutes or more in a state determined as stagnating, the conversation supporter 2201 determines that the conversation duration has exceeded the conversation duration threshold time.

If it is determined in step S2401 that the conversation duration has not exceeded the conversation duration threshold time, the controller 303 returns the processing to step S2401. On the other hand, if it is determined in step S2401 that the conversation duration has exceeded the conversation duration threshold time, in step S2402, the controller 303 reacquires the status information associated with the second user 111b from the user information database 311. The processing of step S2402 is the same as the processing of step S2002 illustrated in FIG. 20, and thus detailed description thereof is omitted.

In step S2403, the controller 303 determines whether a contact method with a higher priority than the first communication tool can be selected. Specifically, it is determined whether a contact method indicated by a priority contact method associated with the status information regarding the second user 111b and the urgency regarding the contact information 112 determined in step S602 illustrated in FIG. 6 is registered in the priority contact method information 2205 illustrated in FIG. 22.

The controller 303 determines that the priority contact method associated with the status information regarding the second user 111b and the determined urgency can be selected as a contact method with a higher priority than the first communication tool. On the other hand, if the priority contact method associated with the status information regarding the second user 111b and the urgency regarding the contact information 112 is not registered, the controller 303 determines that it cannot be selected as a contact method with a higher priority than the first communication tool.

If it is determined in step S2403 that a contact method with a higher priority than the first communication tool cannot be selected, the controller 303 transitions the processing to step S700 illustrated in FIG. 7. On the other hand, if it is determined in step S2403 that a contact method with a higher priority than the first communication tool can be selected, in step S2404, the controller 303 executes processing for presenting the contact method to the first user 111a. For example, the processing for presenting the contact method to the first user 111a includes processing for causing the displayer 203a to display a message prompting contact with the second user 111b using the contact method.

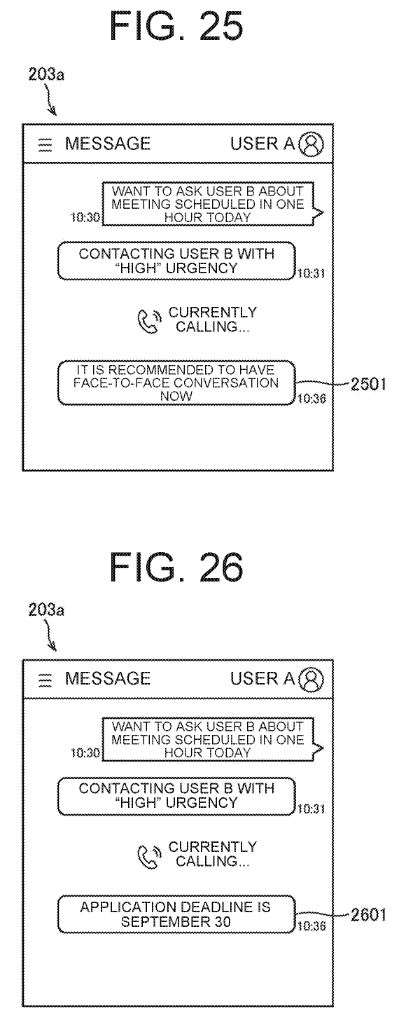

FIG. 25 is a diagram illustrating an example of a screen displayed on the displayer 203a regarding step S2404 illustrated in FIG. 24. For example, when the status information regarding the second user 111b indicates "high workload" and the urgency regarding the contact information 112 indicates "high", in step S2404, the controller 303 transmits a message 2501 to the first terminal 101a, thereby prompting the first user 111a to have a face-to-face conversation with the second user 111b. For example, the message 2501 indicates a notification "It is recommended to have a face-to-face conversation now." This allows the controller 303 to make the first user 111a recognize that a contact method with a higher priority than the first communication tool should be used.

As described above, when the conversation duration between the first user 111a and the second user 111b using the first communication tool exceeds the conversation duration threshold time, the information processing system 100 according to the present embodiment selects a contact method with a higher priority than the first communication tool. This allows the information processing system 100 according to the present embodiment to contribute to smooth contact between the contact source user and the contact destination user.

### Fourth Embodiment

A fourth embodiment will be described with reference to FIG. 26. In the drawings, the same or similar elements are assigned the same reference numerals, and redundant descriptions are omitted.

The configuration of the server apparatus 102 according to the present embodiment is the same as the configuration of the server apparatus 102 illustrated in FIG. 22.

The conversation analysis processor 2204 according to the present embodiment extracts a sentence including at least one of a number and a proper noun from content of a conversation between the first user 111a and the second user 111b. For example, the proper noun includes a person's name.

The conversation supporter 2201 according to the present embodiment presents a message regarding the sentence extracted by the conversation analysis processor 2204 to at least one of the first user 111a and the second user 111b.

When the communication tool used in the conversation between the first user 111a and the second user 111b is telephone, the speech recognition processor 2202 executes speech recognition processing on an audio signal transmitted between the first terminal 101a and the second terminal 101b, and converts the audio signal into text information. The conversation analysis processor 2204 determines whether the text information converted by the speech recognition processor 2202 includes at least one of a number and a proper noun. When the text information includes at least one of the number and the proper noun, the conversation analysis processor 2204 extracts a sentence including the number and the proper noun from the text information.

Alternatively, when the communication tool used in the conversation between the first user 111a and the second user 111b is telephone, the natural language processor 2203 executes natural language processing on the text information converted by the speech recognition processor 2202, and generates a summary sentence regarding the conversation indicated by the text information. The conversation analysis processor 2204 determines whether the summary sentence generated by the natural language processor 2203 includes at least one of a number and a proper noun. When the summary sentence generated by the natural language processor 2203 includes at least one of the number and the proper noun, the conversation analysis processor 2204 extracts a sentence including the number and the proper noun from the summary sentence.

When the communication tool used in the conversation between the first user 111a and the second user 111b is chat, the conversation analysis processor 2204 determines whether a message transmitted and received between the first terminal 101a and the second terminal 101b includes at least one of a number and a proper noun. When the message includes at least one of a number and a proper noun, the conversation analysis processor 2204 extracts a sentence including the number and the proper noun from the message.

When the communication tool used in the conversation between the first user 111a and the second user 111b is chat, the natural language processor 2203 executes natural language processing on the text information converted by the speech recognition processor 2202, and generates a summary sentence regarding the conversation indicated by the text information. The conversation analysis processor 2204 determines whether the summary sentence generated by the natural language processor 2203 includes at least one of a number and a proper noun. When the summary sentence generated by the natural language processor 2203 includes at least one of a number and a proper noun, the conversation analysis processor 2204 extracts a sentence including the number and the proper noun from the summary sentence.

The conversation supporter 2201 generates a message based on the sentence extracted by the conversation analysis processor 2204. Then, the conversation supporter 2201 transmits the generated message to at least one of the first terminal 101a and the second terminal 101b.

For example, when the conversation supporter 2201 transmits the message generated by the conversation supporter 2201 to the first terminal 101a and the second terminal 101b, the controller 205 of the first terminal 101a causes the displayer 203 of the first terminal 101a to display the message, and the controller 205 of the second terminal 101b causes the displayer 203 of the second terminal 101b to display the message. Alternatively, each of the first terminal 101a and the second terminal 101b may be configurable based on a user operation as to whether the controller 205 causes the displayer 203 to display the message generated by the conversation supporter 2201.

FIG. 26 is a diagram illustrating an example of a screen displayed on the displayer 203a. For example, assume that the first communication tool is telephone, and a telephone call is established between the first user 111a and the second user 111b. In this case, while the first user 111a and the second user 111b are on the telephone call, the speech recognition processor 2202 executes speech recognition processing on an audio signal transmitted between the first terminal 101a and the second terminal 101b, and converts the audio signal into text information. That is, the speech recognition processor 2202 converts the conversation between the first user 111a and the second user 111b into text information.

Then, assume that while the first user 111a and the second user 111b are on the telephone call, the first user 111a or the second user 111b states "Regarding the application date, it has been decided as September 30". In this case, the conversation analysis processor 2204 determines that the text information converted by the speech recognition processor 2202 includes a number, and extracts the sentence "Regarding the application date, it has been decided as September 30" from the text information. The conversation supporter 2201 generates a message 2601 "Application date is September 30" from the sentence "Regarding the application date, it has been decided as September 30". Then, the conversation supporter 2201 transmits the message 2601 to the first terminal 101a. The controller 205 of the first terminal 101a causes the displayer 203 of the first terminal 101a to display the message 2601. This allows the information processing system 100 according to the present embodiment to make the first user 111a recognize that the application date is September 30, during the conversation between the first user 111a and the second user 111b and after the first user 111a and the second user 111b end the conversation.

Although FIG. 26 illustrates that the message 2601 is displayed on the displayer 203 of the first terminal 101a, this is not intended to be limiting. For example, when the conversation supporter 2201 transmits the message 2601 to the first terminal 101a and the second terminal 101b, the controller 205 of the first terminal 101a causes the displayer 203 of the first terminal 101a to display the message 2601, and the controller 205 of the second terminal 101b causes the displayer 203 of the second terminal 101b to display the message 2601.

As described above, when content of the conversation between the first user 111a and the second user 111b includes at least one of a number and a proper noun, the information processing system 100 according to the present embodiment causes the displayer 203 to display a message including the number and the proper noun. This allows the information processing system 100 according to the present embodiment to make the user recognize important information in the conversation between the first user 111a and the second user 111b, during the conversation between the first user 111a and the second user 111b and after the first user 111a and the second user 111b end the conversation. This allows the information processing system 100 according to the present embodiment to contribute to smooth contact between the contact source user and the contact destination user.

### Fifth Embodiment

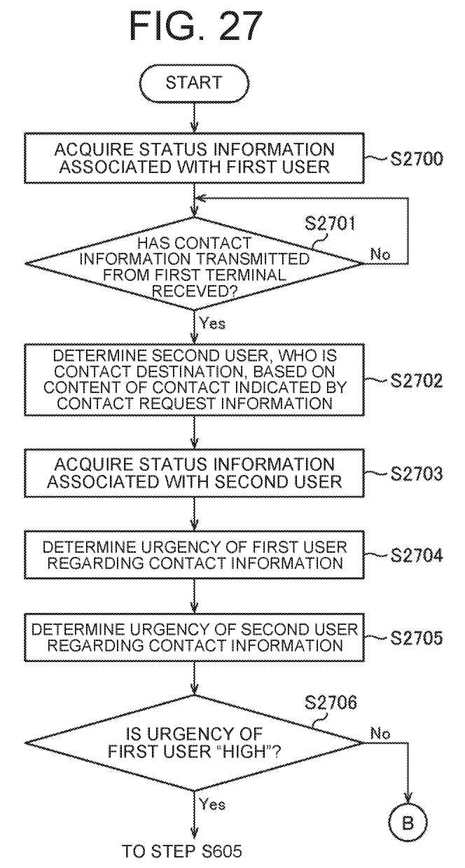

A fifth embodiment will be described with reference to FIGS. 27 to 29. In the drawings, the same or similar elements are assigned the same reference numerals, and redundant descriptions are omitted.

The controller 303 executes processing for determining a communication tool based on urgency regarding the contact information 112 and status information indicating a state of the second user 111b. Alternatively, the controller 303 executes processing for determining a communication tool based on a degree of time constraint of the second user 111b regarding the contact information 112 and status information indicating a state of the second user 111b. Specifically, the controller 303 determines a communication tool from a plurality of communication tools associated with the degree of time constraint of the second user 111b regarding the contact information 112 and the status information indicating the state of the second user 111b. When executing the processing for determining the communication tool, the controller 303 determines the degree of time constraint of the second user 111b regarding the contact information 112, based on the status information indicating the state of the second user 111b and the content of the contact.

Further, when contact is not established between the first user 111a and the second user 111b via the first communication tool, the controller 303 according to the present embodiment executes processing for notifying a user different from the second user 111b and capable of handling the content of the contact, of the content of the content.

FIG. 27 is a flowchart illustrating an example of an operation of the server apparatus 102 according to the present embodiment. The processing of steps S2700 to S2701 is the same as the processing of steps S600 to S601 illustrated in FIG. 6, and thus detailed description thereof is omitted.

In step S2702, the controller 303 determines the second user 111b, who is the contact destination, based on the content of the contact. In step S2703, the controller 303 acquires status information associated with the second user 111b, who was determined in step S2702, from the user information database 311. The processing of steps S2702 to S2703 is the same as the processing of steps S603 to S604 illustrated in FIG. 6, and thus detailed description thereof is omitted.

In step S2704, the controller 303 determines urgency of the first user 111a regarding the contact information 112 received in step S2701. The processing of step S2704 is the same as the processing of step S602 illustrated in FIG. 6, and thus detailed description thereof is omitted.

In step S2705, the controller 303 determines the degree of time constraint of the second user 111b regarding the contact information as urgency of the second user 111b.

For example, the controller 303 determines the degree of time constraint of the second user 111b based on at least one of the content of the contact and schedule information of the second user 111b. Specifically, the controller 303 requests the schedule information of the second user 111b from the second terminal 101b. The controller 205 of the second terminal 101b transmits the schedule information of the second user 111b stored in the storage 204 to the server apparatus 102 in response to the request from the server apparatus 102. Here, assume that the contact information 112 indicates content of a contact "Want to ask about Meeting Y-1 to be held in one hour". Furthermore, assume that the schedule information of the second user 111b indicates that the second user 111b is scheduled to attend "Meeting Y-1" indicated in the content of the contact. In this case, the controller 303 determines that the degree of time constraint of the second user 111b is "high" based on the fact that the second user 111b is scheduled to attend Meeting Y-1 in one hour.

Alternatively, assume that the schedule information of the second user 111b indicates that the user is scheduled to attend an important meeting within a preset time. For example, the preset time is one hour. For example, the important meeting is a meeting attended by executives of the organization to which the second user 111b belongs. Alternatively, the important meeting may be a meeting attended by more than a predetermined number of people. For example, the predetermined number is 20 people. In this case, the controller 303 determines that the degree of time constraint of the second user 111b is "high" based on the fact that the second user 111b is scheduled to attend the important meeting within the preset time.

In step S2706, the controller 303 determines whether the urgency of the first user 111a determined in step S2704 is "high".

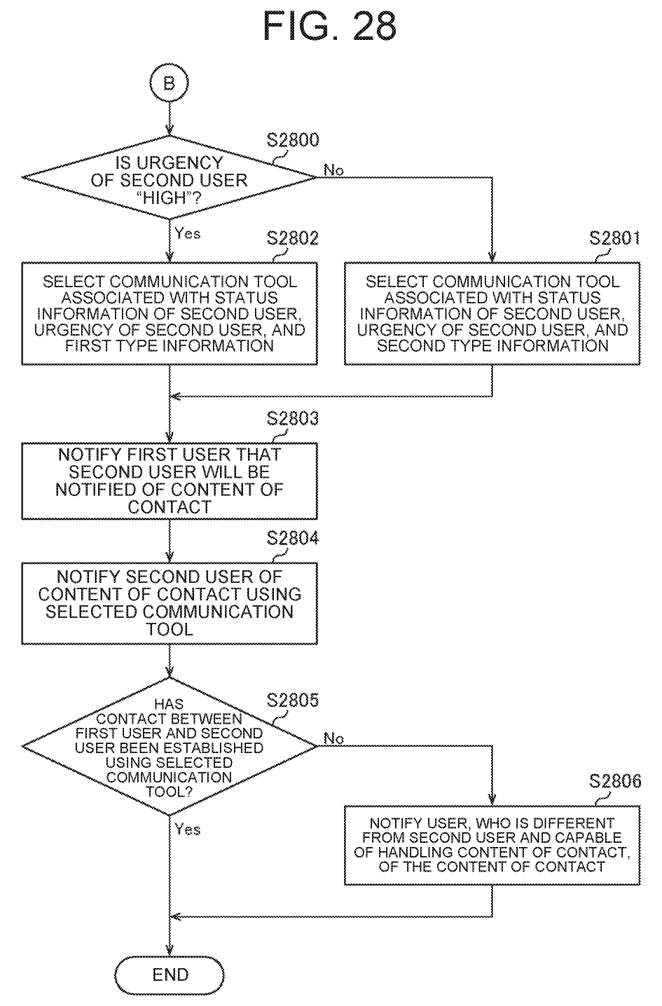

If it is determined in step S2706 that the urgency of the first user 111a is "high", the controller 303 transitions the processing to step S605 illustrated in FIG. 6. On the other hand, if it is not determined in step S2706 that the urgency of the first user 111a is "high", the controller 303 transitions the processing to step S2800 illustrated in FIG. 28.

FIG. 28 is a flowchart illustrating an example of the operation of the server apparatus 102 subsequent to FIG. 27.

In step S2800, the controller 303 determines whether the urgency of the second user 111b determined in step S2705 illustrated in FIG. 27 is "high". That is, if it is not determined that the urgency of the first user 111a is "high", the controller 303 determines whether the urgency of the second user 111b is "high".

If it is determined in step S2800 that the urgency of the second user 111b is not "high", in step S2801, the controller 303 selects the communication tool associated with the status information of the second user 111b, the urgency of the second user 111b, and the second type information in the communication tool information 312. Note that if the second type information is not associated with the status information regarding the second user 111b and the urgency of the second user 111b, the controller 303 may select the communication tool associated with the status information of the second user 111b, the urgency of the second user 111b, and the first type information in the communication tool information 312.

On the other hand, if it is determined in step S2800 that the urgency of the second user 111b is "high", in step S2802, the controller 303 selects the communication tool associated with the status information of the second user 111b, the urgency of the second user 111b, and the first type information in the communication tool information 312. By the controller 303 executing the processing of step S2802, the information processing system 100 according to the present embodiment can select the communication tool based on the urgency of the contact destination user, when the contact is not urgent for the contact source user but is urgent for the contact destination user.

In step S2803, the controller 303 notifies the first user 111a that the second user 111b will be notified of the content of the contact.

In step S2804, the controller 303 notifies the second user 111b of the content of the contact using the communication tool selected in step S2801 or step S2802.

In step S2805, the controller 303 determines whether contact has been established between the first user 111a and the second user 111b using the selected communication tool. If it is determined in step S2805 that contact has been established between the first user 111a and the second user 111b using the selected communication tool, the controller 303 ends the processing. On the other hand, if it is determined in step S2805 that contact has not been established between the first user 111a and the second user 111b using the selected communication tool, in the processing of step S2806, the controller 303 notifies a third user, who is different from the second user 111b and capable of handling the content of the contact.

For example, the third user is a user who belongs to the same group as the second user 111b. For example, it is assumed that information identifying a group to which the user 111 belongs is further registered in the user information database 311 in association with the user identification information. In this case, the third user is a user who is indicated by the information identifying the group as belonging to the same group as the second user 111b.

Further, it is assumed that information indicating a position of the user 111 within the group is further registered in the user information database 311 in association with the user identification information. In this case, the third user is a user who is indicated by the information indicating the position within the group as being a supervisor of the second user 111b.

Alternatively, when it is determined that contact has not been established between the first user 111a and the second user 111b using the selected communication tool, the controller 303 determines one or more users belonging to the same group as the second user 111b as third user candidates.

The controller 303 may select, from the third user candidates, a user who can establish contact with the first user 111a, as the third user, based on the status information. For example, the controller 303 calculates status evaluation information for each of the one or more users belonging to the same group as the second user 111b by inputting the status information into the evaluation model. Then, the controller 303 selects, from the one or more users belonging to the same group as the second user 111b, a user who is in a state capable of establishing contact with the first user 111a using the communication tool selected in step S2805, as the third user, based on the status evaluation information.

Alternatively, when the status information registered in the user information database 311 indicates schedule information of the user 111, the controller 303 may determine the third user based on the content of the contact indicated by the contact information 112 and the schedule information of the user 111 indicated by the status information. For example, assume that the contact information 112 indicates content of a contact "Want to ask about Meeting Y-1 to be held in one hour". In this case, the controller 303 determines, as third user candidates, one or more users 111 who are scheduled to attend "Meeting Y-1" based on the schedule information of the user 111 indicated by the status information, among the plurality of users 111 registered in the user information database 311, and who are different from the second user 111b.

Then, the controller 303 determines the third user from the specified one or more users 111. For example, the controller 303 determines, from the specified one or more users 111, a user 111 who is indicated as being a supervisor of the second user 111b, as the third user. This allows the controller 303 to notify an appropriate user according to the content of the contact, of the content of the contact, even when contact cannot be established between the first user 111a and the second user 111b using the selected communication tool.

Further, when the controller 303 determines a plurality of third user candidates, the controller 303 transmits information identifying the determined plurality of third user candidates to the first terminal 101a. For example, the information identifying the third user candidates indicates the names and contact information of the third user candidates. The controller 205 of the first terminal 101a may cause the displayer 203 to display the information identifying the plurality of third user candidates. In this case, the controller 205 of the first terminal 101a may determine the third user from the plurality of third user candidates based on an operation of the first user 111a. That is, the information processing system 100 according to the present embodiment can allow the contact source user to select a new contact destination from a plurality of users capable of handling the content of the contact.

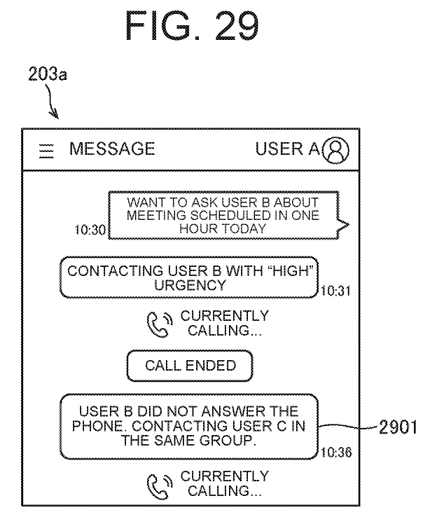

FIG. 29 is a diagram illustrating an example of a screen displayed on the displayer 203 regarding step S2806 illustrated in FIG. 28. For example, assume that the urgency of the second user 111b indicates "high", and it is determined in step S2805 illustrated in FIG. 27 that contact is not established between the first user 111a and the second user 111b, and the controller 303 has determined User C as the third user. In this case, in step S2806 illustrated in FIG. 27, the controller 303 transmits a message 2901 to the first terminal 101a. For example, the message 2901 indicates a notification "User B did not answer the phone. Contacting User C in the same group." This allows the controller 303 to make User A, who is the first user 111a, recognize that User C, who is capable of handling the content of the contact, will be notified of the content of the contact, when contact is not established between the first user 111a and the second user 111b.

As described above, the information processing system 100 according to the present embodiment can determine an appropriate communication tool according to the state of the second user 111b and the degree of time constraint of the second user 111b. This allows the information processing system 100 according to the present embodiment to contribute to smooth contact between the contact source user and the contact destination user.

Each processing executed in the above embodiments is not limited to the processing aspects exemplified in each embodiment. The functional blocks described above may be realized using either logic circuits (hardware) formed in an integrated circuit, or software using a CPU. Each processing executed in the above embodiments may be executed by a plurality of computers. For example, for the processing executed by each functional block of the terminal 101 and the processing executed by each functional block of the server apparatus 102, a part of the processing may be executed by another computer, or all the processing may be shared and executed by a plurality of computers.

The present disclosure is not limited to the above-described embodiments, and may be replaced by a configuration substantially the same as the configuration described in the above-described embodiments, a configuration that exhibits the same operational effects, or a configuration that can achieve the same object. The present disclosure also includes, within its technical scope, embodiments obtained by appropriately combining technical means disclosed in different embodiments. Furthermore, new technical features can be formed by combining the technical means disclosed in each embodiment.

What is claimed is:

1. An information processing apparatus comprising:
an acquirer that acquires contact information indicating content of a contact to a second user, the content being input according to an operation of a first user; and
one or more controllers that execute determining a communication tool based on urgency regarding the contact information and status information indicating a state of the second user, and execute processing for presenting information indicating the communication tool to the first user.

2. The information processing apparatus according to claim 1, wherein the determining includes processing for determining the urgency from the content of the contact.

3. The information processing apparatus according to claim 1, wherein the determining includes processing for calculating a degree of workload of the second user from the status information, and the communication tool is a tool associated with the degree and the urgency.

4. The information processing apparatus according to claim 1, wherein the one or more controllers execute determining the communication tool based on a degree of time constraint of the second user regarding the contact information and the status information indicating the state of the second user, and execute the processing for presenting the information indicating the communication tool to the first user.

5. The information processing apparatus according to claim 4, wherein the determining includes processing for determining the degree of time constraint based on at least one of the status information and the content of the contact.

6. The information processing apparatus according to claim 1, wherein the communication tool includes a first communication tool and a second communication tool, and the one or more controllers execute processing for notifying the second user of the content of the contact by the second communication tool when no contact from the second user to the first user is made via the first communication tool.

7. The information processing apparatus according to claim 6, wherein the one or more controllers execute processing for prompting, using the second communication tool, the second user to contact the first user by the first communication tool when no contact from the second user to the first user is made via the first communication tool.

8. The information processing apparatus according to claim 1, wherein the one or more controllers notify the second user of the content of the contact using the communication tool, and execute processing for presenting, to the first user, a communication tool with a higher priority than the communication tool when a time during which contact between the first user and the second user is not established exceeds a predetermined response threshold time.

9. The information processing apparatus according to claim 1, further comprising a conversation supporter that presents information for supporting the conversation to at least one of the first user and the second user based on a conversation between the first user and the second user.

10. The information processing apparatus according to claim 9, wherein the conversation supporter proposes a communication method different from the communication tool to at least one of the first user and the second user when at least one of content of the conversation and a duration of the conversation indicates stagnation of the conversation.

11. The information processing apparatus according to claim 9, further comprising a conversation analysis processor that extracts a sentence including at least one of a number and a proper noun from content of the conversation, wherein
the conversation supporter presents a message related to the sentence to at least one of the first user and the second user.

12. The information processing apparatus according to claim 1, wherein the communication tool includes a first communication tool and a second communication tool, and the one or more controllers execute processing for notifying a user, who is different from the second user and is capable of responding to the content of the contact, of the content of the contact when contact between the first user and the second user is not established by the first communication tool.

13. The information processing apparatus according to claim 1, wherein the status information includes at least one selected from the group consisting of operational state information of a terminal used by the second user, operation information regarding an operation received by a peripheral device connected to the terminal, schedule information of the second user, attendance information of the second user, and task information indicating a task assigned to the second user.

14. An information processing system comprising:
a first terminal operated by a first user;
a second terminal operated by a second user; and
a server apparatus communicable with the first terminal and the second terminal, wherein
the server apparatus includes:
an acquirer that acquires, from the first terminal, contact information indicating content of a contact to the second user, the content being input according to an operation of the first user; and
one or more controllers that execute determining a communication tool based on urgency regarding the contact information and status information indicating a state of the second user, and execute processing for presenting information indicating the communication tool to the first user.

15. A communication control method causing a computer to execute processing comprising:
acquiring contact information indicating content of a contact to a second user, the content being input according to an operation of a first user;
determining a communication tool based on urgency regarding the contact information and status information indicating a state of the second user; and
presenting information indicating the communication tool to the first user.
